(19) United States
(12) Patent Application Publication
(10) Pub. No.: US 2024/0219602 A1
(43) Pub. Date: Jul. 4, 2024

(54) SYSTEMS AND METHODS FOR DIGITAL GAMMA-RAY LOG GENERATION USING PHYSICS INFORMED MACHINE LEARNING

(71) Applicant: Schlumberger Technology Corporation, Sugar Land, TX (US)

(72) Inventors: Indranil Roychoudhury, Sunnyvale, CA (US); Crispin Chatar, Katy, TX (US); Jose R. Celaya Galvan, Sunnyvale, CA (US); Prasham Sheth, Sunnyvale, CA (US); Mengdi Gao, Burlingame, CA (US); Sai Shravani Sistla, Sunnyvale, CA (US); Priya Mishra, Menlo Park, CA (US)

(21) Appl. No.: 18/537,910

(22) Filed: Dec. 13, 2023

Related U.S. Application Data
(60) Provisional application No. 63/477,597, filed on Dec. 29, 2022.

(51) Int. Cl. G01V 20/00; G06F 30/27

(52) U.S. Cl. CPC G01V 20/00; G06F 30/27

(57) ABSTRACT

Systems and methods for generating digital gamma-ray logs for target wells based on combined physics and machine learning model using real-time information (e.g., drilling parameters, survey data, gamma-ray logs, and so forth) obtained from offset wells analogous to the subject well in terms of gamma-ray readings. The systems and methods may provide solutions that may lower the cost of Measuring While Drilling (MWD) and/or Logging While Drilling (LWD) process and facilitate the users (e.g., drillers, geoscientists, and so forth) to make enhanced data driven decisions.

### CROSS-REFERENCE TO RELATED APPLICATION

This application claims priority to and the benefit of U.S. Provisional Patent Application Ser. No. 63/477,597, entitled “SYSTEMS AND METHODS FOR DIGITAL GAMMA-RAY LOG GENERATION USING PHYSICS-INFORMED MACHINE LEARNING,” filed Dec. 29, 2022, which is hereby incorporated by reference in its entirety for all purposes.

### FIELD OF THE INVENTION

Aspects of the disclosure relate to systems and methods for generating digital drilling or formation evaluation logs. More specifically, aspects of the disclosure provide for digital gamma-ray generation based on a physics-informed machine learning framework using offset well data.

### BACKGROUND INFORMATION

Hydrocarbon resources, such as oil and gas deposits, are present in the strata of the Earth's crust. The hydrocarbon resources may be accessed by various drillings (e.g., drilling vertical or horizontal wells into the crust). In certain cases, a good understanding of the strata (e.g., physical properties of subsurface geologic formations) in close proximity to a proposed target zone (or pay zone) may help to minimize drilling risks and/or optimize hydrocarbon extractions. However, direct observations of the subsurface geologic formations may be difficult.

Various technologies have been developed to provide direct and/or inferred measurement of the subsurface geologic formations. For example, measurement tools may be lowered into a wellbore to map a path of a well and record physical properties of subsurface formations (e.g., rock formations) surrounding the wellbore. Recorded physical properties may provide vital information for locating and extracting hydrocarbon resources and other aspects (e.g., safety, environment, or cost) related to hydrocarbon productions. In some cases, a wireline logging may be performed by lowering a logging tool (e.g., a string of one or more instruments) positioned at the end of a wireline into a borehole and recording physical properties of the subsurface formations using a variety of sensors (e.g., electromagnetic, optical, acoustic, or nuclear sensors). Wireline logs may indicate natural gamma-ray, electrical, acoustic, stimulated radioactive responses, electromagnetic, nuclear magnetic resonance, pressure, and other properties of rock formations and contained fluids.

However, in some cases, a deployment of measurement tools (e.g., logging tools) in a wellbore to acquire subsurface formation properties may significantly increase cost of drillings. In some cases, one or more measurement tools deployed a wellbore may have certain issues (e.g., sensor problems) resulting in missing or unusable measurement data. In some cases, measurement data in a wellbore may not be accessible to certain users (e.g., restrictions applied to measurement data by data owners to prevent a data sharing with other users). Thus, a method to generate digital records (e.g., synthetic logs) indicative of the subsurface formation properties (e.g., gamma-ray) associated with a wellbore described above may be desired.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one non-limiting embodiment, a method for generating log data may include receiving input data associated with a target well in an area comprising a plurality of subsurface formations and one or more offset wells that are analogous to the target well. The method may also include building a machine learning model using one or more algorithms based at least in part on the input data associated with the target well and one or offset wells and training the machine learning model using at least the input data associated with the one or more offset wells. The method may further include generating the log data associated with the target well using the machine learning model based at least in part on the input data associated with the target well.

### BRIEF DESCRIPTION OF THE DRAWINGS

Various aspects of this disclosure may be better understood upon reading the following detailed description and upon reference to the drawings, in which:

FIG. 1 depicts an example wellsite system for measuring borehole data using various downhole tools and surface tools, in accordance with embodiments of the present disclosure;

FIG. 2 depicts a well control system configured to control the wellsite system of FIG. 1, in accordance with embodiments of the present disclosure;

FIG. 3 depicts an example scenario of missing/noisy gamma-ray logs, in accordance with embodiments of the present disclosure;

FIG. 4 depicts another example scenario of missing/noisy gamma-ray logs, in accordance with embodiments of the present disclosure;

FIG. 5 depicts an example block diagram of a first formulation for gamma-ray log generation using data from the wellsite system of FIG. 1 and the well control system of FIG. 2, in accordance with embodiments of the present disclosure;

FIG. 6 depicts an example model building process including a two-stage machine learning framework based on the first formulation of FIG. 4, in accordance with embodiments of the present disclosure;

FIG. 7 depicts an example physics-informed machine learning (PIML) framework for a model training process using the two-stage machine learning framework of FIG. 6, in accordance with embodiments of the present disclosure;

FIG. 8 depicts examples of predicted gamma-ray (GR) logs of a first offset well using the physics-informed machine learning (PIML) framework of FIG. 7, in accordance with embodiments of the present disclosure;

FIG. 9 depicts examples of predicted gamma-ray (GR) logs of a second offset well using the physics-informed machine learning (PIML) framework of FIG. 7, in accordance with embodiments of the present disclosure;

FIG. 10 depicts examples of predicted gamma-ray (GR) logs of a third offset well using the physics-informed machine learning (PIML) framework of FIG. 7, in accordance with embodiments of the present disclosure;

FIG. 11 depicts examples of predicted gamma-ray (GR) logs of a fourth offset well using the physics-informed machine learning (PIML) framework of FIG. 7, in accordance with embodiments of the present disclosure;

FIG. 12 depicts examples of predicted gamma-ray (GR) logs of a fifth offset well using the physics-informed machine learning (PIML) framework of FIG. 7, in accordance with embodiments of the present disclosure;

FIG. 13 depicts examples of QQ plots (quantile-quantile plots) corresponding to the first offset well, in accordance with embodiments of the present disclosure;

FIG. 14 depicts examples of QQ plots (quantile-quantile plots) corresponding to the second offset well, in accordance with embodiments of the present disclosure;

FIG. 15 depicts examples of QQ plots (quantile-quantile plots) corresponding to the third offset well, in accordance with embodiments of the present disclosure;

FIG. 16 depicts examples of QQ plots (quantile-quantile plots) corresponding to the fourth offset well, in accordance with embodiments of the present disclosure;

FIG. 17 depicts examples of QQ plots (quantile-quantile plots) corresponding to the fifth offset well, in accordance with embodiments of the present disclosure;

FIG. 18 depicts an example flow diagram of a process for extraction of formation information, in accordance with embodiments of the present disclosure;

FIG. 19 depicts example plots showing test results for evaluating the process of FIG. 18 for extraction of formation information, in accordance with embodiments of the present disclosure;

FIG. 20 depicts a first set of example gamma-ray logs output from the process of FIG. 18 before True Vertical Depths Estimated (TVDE) alignment, in accordance with embodiments of the present disclosure;

FIG. 21 depicts the first set of example gamma-ray logs output from the process of FIG. 18 after the True Vertical Depths Estimated (TVDE) alignment, in accordance with embodiments of the present disclosure;

FIG. 22 depicts a second set of example gamma-ray logs output from the process of FIG. 18 before True Vertical Depths Estimated (TVDE) alignment, in accordance with embodiments of the present disclosure;

FIG. 23 depicts the second set of example gamma-ray logs output from the process of FIG. 18 after the True Vertical Depths Estimated (TVDE) alignment, in accordance with embodiments of the present disclosure;

FIG. 24 depicts an example flow diagram of a method for generating a physics model, in accordance with embodiments of the present disclosure;

FIG. 25 depicts a set of plots including true gamma-ray values and corresponding predicted gamma-ray (GR) values generated from the physics model of FIG. 24, for a set of offset wells in a first depth range, in accordance with embodiments of the present disclosure;

FIG. 26 depicts a set of plots including smoothed true gamma-ray values and corresponding smoothed predicted gamma-ray (GR) values generated from the physics model of FIG. 24, for the set of offset wells in the first depth range, in accordance with embodiments of the present disclosure;

FIG. 27 depicts a set of plots including true gamma-ray values and corresponding predicted gamma-ray (GR) values generated from the physics model of FIG. 24, for the set of offset wells in a second depth range, in accordance with embodiments of the present disclosure;

FIG. 28 depicts a set of plots including smoothed true gamma-ray values and corresponding smoothed predicted gamma-ray (GR) values generated from the physics model of FIG. 24, for the set of offset wells in the second depth range, in accordance with embodiments of the present disclosure;

FIG. 29 depicts an example block diagram of a second formulation for gamma-ray log generation using data from the wellsite system of FIG. 1 and the well control system of FIG. 2, in accordance with embodiments of the present disclosure;

FIG. 30 depicts a flow diagram of the physics-informed machine learning (PIML) framework based on the formulation of FIG. 29 for a training process.

FIG. 31 depicts a flow diagram of the physics-informed machine learning (PIML) framework based on the formulation of FIG. 29 for an inference process.

FIG. 32 depicts an example flow diagram of a method for selecting offset wells for the physics-informed machine learning (PIML) framework, in accordance with embodiments of the present disclosure;

FIG. 33 depicts a set of plots including true gamma-ray values and corresponding predicted gamma-ray (GR) values using the second formulation of FIG. 29 based on selected wells using the method of FIG. 32, in accordance with embodiments of the present disclosure;

FIG. 34 depicts a set of plots including smoothed true gamma-ray values and corresponding smoothed predicted gamma-ray (GR) values using the second formulation of FIG. 29 based on selected wells using the method of FIG. 32, in accordance with embodiments of the present disclosure;

FIG. 35 depicts a set of plots including true gamma-ray values and corresponding predicted and weighted gamma-ray (GR) values using the second formulation of FIG. 29 based on selected wells using the method of FIG. 32, in accordance with embodiments of the present disclosure; and

FIG. 36 depicts a set of plots including smoothed true gamma-ray values and corresponding smoothed predicted and weighted gamma-ray (GR) values using the second formulation of FIG. 29 based on selected wells using the method of FIG. 32, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first”, “second” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the data processing system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Similarly, as used herein, the term “substantially parallel” may be used to define downhole tools, formation layers, and so forth, that have longitudinal axes that are parallel with each other, only deviating from true parallel by a few degrees of each other. For example, a downhole tool that is substantially parallel with a formation layer may be a downhole tool that traverses the formation layer parallel to a boundary of the formation layer, only deviating from true parallel relative to the boundary of the formation layer by less than 5 degrees, less than 3 degrees, less than 2 degrees, less than 1 degree, or even less.

The oil and gas industry often uses wireline logging to obtain a continuous record of physical properties of a subsurface formation (e.g. rock formation). The wireline logging may include measurements and analysis of geophysical data performed as a function of wellbore depth. The measurements and the associated analysis may be used to infer further properties of the subsurface formation, such as hydrocarbon saturation and formation pressure, thereby facilitating decision-making for further drillings and productions to extract natural resources (e.g., hydrocarbon resources) in close proximity to the subsurface formation.

The measurements may be recorded either at surface or in a borehole to electronic data format (e.g., well log) and provided to users. Well logging may be performed during a drilling process (e.g., Measuring While Drilling (MWD), Logging While Drilling (LWD)) to provide real-time information about the subsurface formations being penetrated by the borehole, or after a well reaches a target such that the whole depth of the borehole may be logged. Logs collected during the process of MWD may include gamma-ray logs. The gamma-ray logs may help drillers as well as geoscientists to infer a distribution of a formation of rocks through which the drilling is conducted. A process of collecting gamma-ray values may include a tool deployed within a Bottom Hole Assembly (BHA), which may use certain gamma-ray particles ejected from different elements of the BHA. However, the deployment of tools (e.g., logging tools) may add up to the cost of drilling significantly.

Embodiments of the present disclosure provide systems and methods to digitally generate gamma-ray logs for subject wells of choice based on real-time information obtained from offset wells. The techniques described herein may provide solutions that may lower the cost of MWD and/or LWD processes and facilitate the geoscientists to make enhanced data driven decisions.

### Section 1 Well Log Data Acquisition

In certain embodiments, multiple wells may be drilled within a specific area of interest having potential hydrocarbon deposits. To reduce drilling cost, a method to digitally generate gamma-ray logs may be implemented, thereby avoiding a deployment of the logging tools for at least one of the wells where digitally generated logs (e.g., gamma-ray logs) may be obtained. The digital logs may be generated using data collected from other nearby wells with certain assumptions, such as assuming that the nearby wells are analogous to the subject well in terms of gamma-ray readings (e.g., a distribution of the subsurface formations within the specific area are similar).

In certain embodiments, a digital gamma-ray log generation based on a physics-informed machine learning (PIML) framework may be used to study and recognize certain patterns from real-time data obtained from offset wells, which may indicate information associated with measured gamma-rays and drilling parameters. For example, a mathematic model may be generated (e.g., using machine learning) and compelled to learn relationships between drilling (e.g., surface drilling) measurements and the subsurface formations and relationships between the drilling measurements together with the subsurface formations and the measured gamma-rays. In some cases, the mathematic model may generate gamma-rays (e.g., predicted gamma-rays) consistent with the subsurface formations associated with a subject well (or target well) being drilled. In some cases, the predicted gamma-rays generated by the mathematic model may not only depend on the relationships between surface drilling measurements and the measured gamma-rays that is used for machine learning. In such cases, the mathematic model may be generalized to have a capability of being deployed into applications using a retraining on the offset wells with no or limited changes in the model structure or complexity.

The digital gamma-ray log generation (e.g., the PIML framework) described in the present disclosure may be used to generate the digital gamma-ray logs in real time with reduced input data dependency (e.g., without waiting for a completion of recording all measurement logs) and improved efficiency (e.g., using a real-time online system instead of an offline system that may cause, for example, decision-making latency). The digital gamma-ray log generation combines physics models with machine learning models to develop the PIML framework, which is more robust than other approaches without using any kind of physics model, which may produce gamma-ray logs that may not be physically valid. Moreover, using combined physics models with machine learning models may increase the capability of identifying certain important geophysical information, such as a trajectory of the well based on azimuth, inclination, depth, or any other relevant information. This may enable a user to include different geological effects, such as faults and different positions of the formation tops, into the mathematic model, thereby generating (e.g., by model predictions) more accurate gamma-ray logs.

Moreover, the physics-informed machine learning (PIML) framework includes a combination of different drilling parameters. Because of a design of the PIML framework combines the physics models with machine learning models, automated data extractions, formation classifications, and formation-based regression modules, a relatively higher robustness of the framework with reduced dependences on tuning model parameters (e.g., network hyperparameters) may be obtained. In comparison, some other approaches (e.g., generative adversarial network (GAN)) may only consider a single drilling parameter as a condition for model development. Such approaches may have difficulties in tuning the hyperparameters of a network to maintain performance of the network without degradation.

Although the embodiments described herein are related to gamma-ray readings, it should be noted that the techniques described herein may be applied to any types of logging data (e.g., electrical, electromagnetic, acoustic, stimulated radioactive, nuclear magnetic resonance, pressure, resistivity, or optical logs) representing various information associated with the subsurface formations.

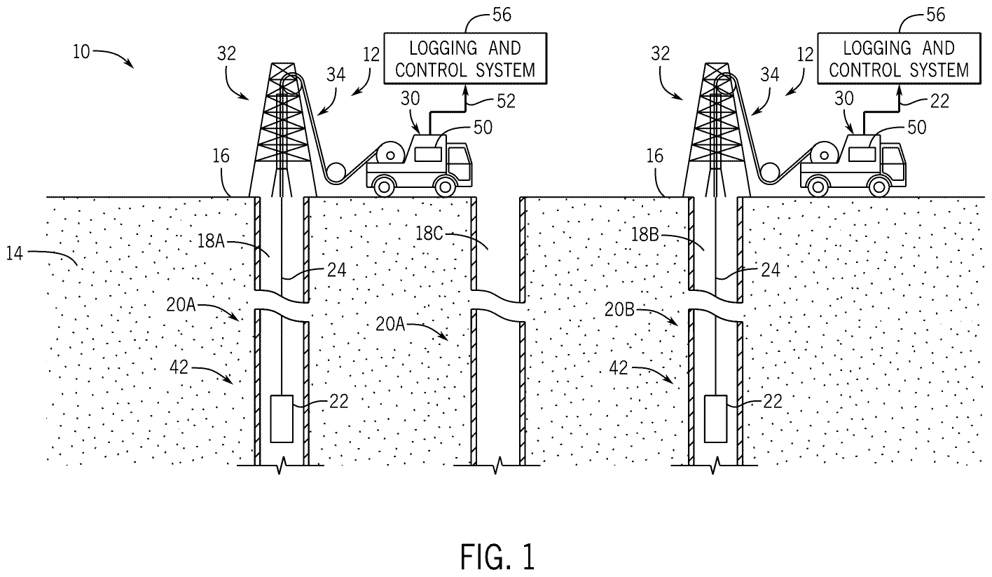

By way of introduction, FIG. 1 depicts an example wellsite system 10 for measuring borehole data using various downhole tools (e.g., logging tools) and surface tools according to one or more aspects of the present disclosure. Surface acquisition systems 12 are located on a wellsite surface 16 above a geological formation 14 (e.g., a subsurface formation) into which multiple wellbores 16A-16C extend from the wellsite surface 16. The wellbores 18A and 18B are located within offset wells 20A and 20B, respectively. The wellbore 18C is located within a subject well 20C. Each of the offset wells 20A and 20B are located at a site having an offset distance with respect to a site of the subject well 20C.

An offset well (e.g., offset well 20A or 20B) may include an existing wellbore that may be used as a guide for planning a well (e.g., subject well 20C) and/or well performance benchmarking. In some cases, offset well data may be combined with seismic data and other relevant information (e.g., local geological surveys, prior experience). In some cases, offset well data may be limited (e.g., due to competition between different oil and gas operators).

Downhole equipment 42 may be deployed in the wellbores 18A and 18B to acquire various borehole data (e.g., well logs). The downhole equipment 42 may include one or more logging tools 22 that may acquire information associated with the subsurface formations (e.g., rock formations) surrounding the wellbores 18A and 18B. Based on acquired information, certain properties (e.g., lithology) of the subsurface formations may be interpreted by users (e.g., geoscientists) to facilitate decision-making related to a well development process (e.g., well construction of the subject well 20C).

For example, the logging tools 22 may include gamma-ray logging tools that measure naturally occurring gamma radiation that may characterize rocks or sediments associated with the wellbores 18A-18C. The naturally occurring gamma radiation may be emitted primarily from potassium in the structure of clay minerals, radioactive salts in the formation waters, radioactive salts bound to the charged surfaces of clay minerals, potassium associated with feldspars, and radioactive minerals associated with igneous rocks and rock fragments. The gamma-ray response is used for correlation of formations between wells and for estimating volume shale and/or volume clay minerals.

Logging tools 22 may be run downhole on wirelines 24 into the wellbores 18A and 18B respectively by the surface acquisition systems 12. The logging tools 22 may include any suitable measurement devices (e.g., sensors, meters) capable of acquiring borehole data including measurements of various properties (e.g., velocities, porosity, resistivity, natural gamma-ray, electrical, acoustic, stimulated radioactive responses, electromagnetic, nuclear magnetic resonance, pressure, and so forth) associated with the geological formation 14 and contained fluids. In certain embodiments, the logging tools 22 may include data processing components to perform certain pre-processing tasks. In certain embodiments, certain borehole data (e.g., measured log data) from the offset wells 20A and 20B may be used to generate (e.g., using model-based data simulation and prediction) new data (e.g., synthetic log data) for the subject well 20C where no logging tools being deployed.

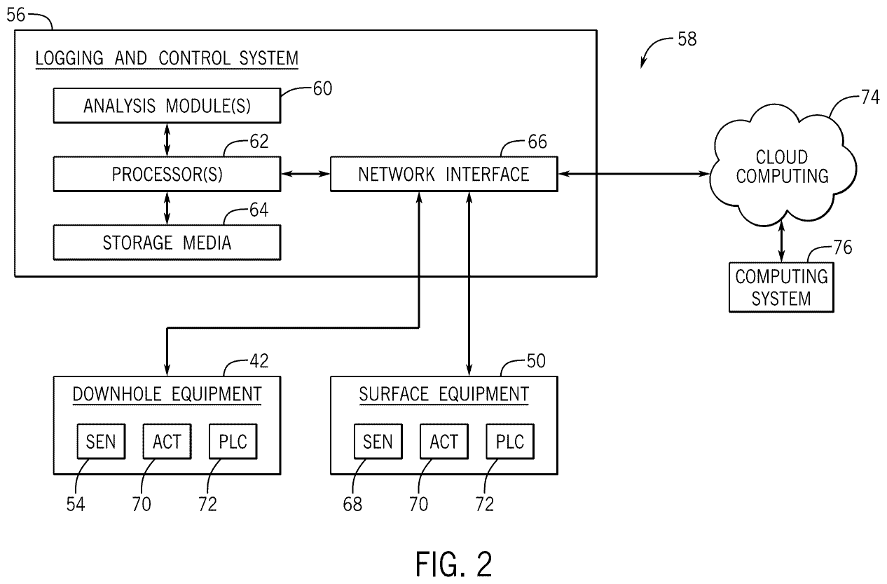

Each surface acquisition system 12 may include a vehicle 30 and a deploying system 32, such as a drilling rig, workover rig, platform, derrick, and/or other surface structures. The borehole data (e.g., log data) related to the geological formation 14 surrounding the offset wells 20A and 20B is gathered by the logging tools 22 and transmitted to the vehicles 30 via the wirelines 24 and cables 34. Each vehicle 30 may include surface equipment 50 configured to collect, store, and/or pre-process the borehole data. Each vehicle 30 may communicate with a logging and control system 56 using certain communication components (e.g., routers, transmitters, and so forth) via data communication lines 52 or wireless connections. The logging and control system 56 may perform data processing and analysis based on the borehole data and other reference data (e.g., seismic data). Additional details with regard to acquiring the borehole data using the downhole equipment 42, surface equipment 50, and logging and control system 56 will be discussed below with reference to FIG. 2.

FIG. 2 illustrates a well control system 58 (e.g., that includes the logging and control system 56) configured to control the wellsite system 10 of FIG. 1. In certain embodiments, the logging and control system 56 may include one or more analysis modules 60 (e.g., a program of computer-executable instructions and associated data) that may be configured to perform various functions of the embodiments described herein. In certain embodiments, to perform these various functions, the one or more analysis modules 60 may execute on one or more processors 62 of the logging and control system 56, which may be connected to one or more storage media 64 of the logging and control system 56. Indeed, in certain embodiments, the one or more analysis modules 60 may be stored in the one or more storage media 64.

In certain embodiments, the computer-executable instructions of the one or more analysis modules 60, when executed by the one or more processors 62, may cause the one or more processors 62 to generate one or more models (e.g., forward model, inverse model, mechanical model, and so forth). Such models may be used by the logging and control system 56 to predict values of operational parameters that may or may not be measured (e.g., using gauges, sensors, and so forth) during well operations.

In certain embodiments, the one or more processors 62 may include a microprocessor, a microcontroller, a processor module or subsystem, a programmable integrated circuit, a programmable gate array, a digital signal processor (DSP), or another control or computing device. In certain embodiments, the one or more processors 62 may include machine learning and/or artificial intelligence (AI) based processors. In certain embodiments, the one or more storage media 64 may be implemented as one or more non-transitory computer-readable or machine-readable storage media. In certain embodiments, the one or more storage media 64 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 60 may be provided on one computer-readable or machine-readable storage medium of the storage media 64, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 64 may be located either in the machine running the machine-readable instructions or may be located at a remote site from which machine-readable instructions may be downloaded over a network for execution.

In certain embodiments, the processor(s) 62 may be connected to a network interface 66 of the logging and control system 56 to allow the logging and control system 56 to communicate with multiple downhole sensors 54 and surface sensors 68, as well as communicate with actuators 70 and/or programmable logic controllers (PLCs) 72 of the surface equipment 50 and of the downhole equipment 42 of a Bottom Hole Assembly (BHA), as described in greater detail herein. In certain embodiments, the network interface 66 may also facilitate the logging and control system 56 to communicate data to cloud computing resources 74, which may in turn communicate with external computing systems 76 to access and/or to remotely interact with the logging and control system 56.

It should be appreciated that the well control system 58 illustrated in FIG. 2 is only one example of a well control system, and that the well control system 58 may have more or fewer components than shown, may combine additional components not depicted in the embodiment of FIG. 2, and/or the well control system 58 may have a different configuration or arrangement of the components depicted in FIG. 2. In addition, the various components illustrated in FIG. 2 may be implemented in hardware, software, or a combination of both hardware and software, including one or more signal processing and/or application specific integrated circuits. Furthermore, the operations of the well control system 58 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

### Section 2 Digital GR Log Generation Using PIML Framework (Example 1)

During a well development or well production process, gamma-ray logs may provide vital measurements for a user (e.g., oil and gas operator) to evaluate oil and gas reservoirs and identify a subsurface formation lithology surrounding a subject well (or target well, such as a development well or a production well). As mentioned previously, certain restrictions and/or limitations, such as costs of deployment of logging tools in a wellbore, logging tool issues (e.g., sensor problems), or restricted logging data usage, may result in missing or unusable logging data in the development well or production well. A digital gamma-ray log generation application described in the present disclosure may be used to generate digital gamma-ray logs indicative of subsurface formation properties associated with a wellbore of the subject well. The digital gamma-ray log generation application may use machine learning to provide robustness to a process of gamma-ray logging when the restrictions and/or limitations described above are applied to the subject well. Logging (e.g., gamma-ray logging) used herein may be in a context of a well construction/production process (e.g., logging while drilling (LWD)). It should be noted that the techniques described herein may be applied to historical well data for which LWD may not be done by the user or for which the user does not have access to the log measurements.

The digital gamma-ray log generation application may include a physics-informed machine learning (PIML) framework to provide robust and real-time solutions to the well construction/production process (e.g., LWD) by synthetically generating gamma-ray values that may be used for remedying missing gamma-ray data (e.g., due to cost of logging tool deployment, data restrictions, or logging tool issues) or replacing unusable (e.g., noisy) gamma-ray data (e.g., due to logging tool limitations).

The PIML framework of the digital gamma-ray log generation application may include various data driven modeling functionalities (e.g., using different machine learning (ML) models) as building blocks for solving a variety of problems in natural resources (e.g., oil, gas) explorations and productions. Such data driven modeling functionalities may help users to understand and use insightful patterns and trends in the collected data (e.g., gamma-ray logs) and solve problems that, in some cases, is not feasible to model using traditional methods.

For example, gamma-ray logging is used as a building block for subsurface formation evaluation, which helps users (e.g., oil and gas operators) make various drilling decisions. Traditionally, well log measurements are collected from a sensing device as a part of the Bottom Hole Assembly (BHA), which may be deployed in a subject well. However, the sensing device may have a faulty condition (e.g., sensor problem) resulting in missing data or unusable data (e.g., noisy data), thereby inhibiting subsequent data processing (e.g., predicting different wireline logs) based on well log measurements. The PIML framework of the digital gamma-ray log generation application described herein may use surface drilling measurements to predict synthetic gamma-ray logs to replace missing or noisy data, thereby avoiding undesired cost and time (e.g., replacing a problematic sensing device or the BHA).

The PIML framework of the digital gamma-ray log generation application may generate synthetic gamma-ray logs using the information obtained from drilling measurements and depth data (e.g., Measured Depth (MD) and True Vertical Depths Estimated (TVDE)). The application may provide user the data from the offset wells (e.g., offset wells 20A and 20B). For example, the application may be used to fill certain gaps in the gamma-ray logs due to tool issues (e.g., sensor problems) using machine learning models. The machine models may take the data from the offset wells as inputs, as well as available valid data from a subject well (e.g., subject well 20C) being drilled in a same or similar region as the offset wells (e.g., based on a direct comparison of geological features of the associated regions). With the help of available valid data from the subject well, the application may align well logs (e.g. gamma-ray logs) using the respective true vertical positions and may trigger the PIML framework of the digital gamma-ray log generation to use the relevant data from the offset wells to replace the invalid data (e.g., missing or noisy data) for the subject well.

It should be noted that the concept of “generating synthetic logging” used herein may be analogous to “estimating” or “computing an approximation” of the physical variables (e.g., gamma-rays) measured in drilling processes (e.g., logging while drilling (LWD) including gamma-ray measurement). The digital gamma-ray log generation application may generate an estimation of a gamma-ray log that approximates the output of a physical sensing device deployed in the subject well during development of the subject well.

Subsurface formation evaluation is important for drilling operations and profits generated subsequently. A variety of metrics may be used for evaluating the subsurface formations. However, certain tools used for estimating the metrics may be costly and/or may have delayed response time (e.g., not capable of real-time decision making). In certain cases, logging tools/sensors may be sensitive and may have damages or malfunctions, thereby outputting no or noisy data. Thus, relying exclusively on sensor data may be problematic because sensors (e.g., gamma-ray sensors) may be prone to hardware/software problems and costly to maintain and install. In the case of logging tool issues, the logging tool may not log any data or log noisy data hindering the process of formation evaluation. The PIML framework of the digital gamma-ray log generation application may provide solutions for replacing or reducing deployments of logging tools that may result in the increased cost for the drilling process.

In certain cases, acquiring wireline logs (e.g., gamma-ray logs, high-resolution acoustic logs, sonic logs, or density logs) includes using relatively expensive sensors that may not be immediately available during an ongoing drilling process. Thus, a model for predicting the gamma-ray measurements in real-time while drilling is desired to have capabilities of using only the surface features (e.g., surface drilling measurements) that are available in real-time. Because gamma-ray measurements may be closely related to the subsurface formations and a relationship between the surface measurements and gamma-ray may be complicated, the model may have complex structures and functions to gauge the complicated relationship.

Moreover, the relationship between the surface measurements and gamma-ray may vary with respect to different subsurface formations and different regions. The PIML framework of the digital gamma-ray log generation application may use the data from the offset wells for learning the particular relationships using the machine learning models. The PIML framework of the digital gamma-ray log generation application may enable selecting offset wells that are analogous to the subject well in terms of gamma-ray readings (e. g., a distribution of the subsurface formations within the specific area are similar). The final model parameters for different sets of offset wells may vary based on the distribution of the data from the offset wells. Additionally, the PIML framework of the digital gamma-ray log generation application may include a single architecture that has a set of parameters (e.g., model parameters) that may be updated using the data from one or more particular offset wells given by a user.

The PIML framework of the digital gamma-ray log generation application may provide the user robust synthetic gamma-ray logs. During a process, the gamma-ray logs from the offset wells are selectively arranged to match different True Vertical Depths Estimated (TVDEs). The selective arrangement may facilitate an alignment for gamma-ray logs from the offset wells in a particular position such that the gamma-ray logs correspond to the same or similar subsurface formations as the subject well (e.g., based on a direct comparison of geological features of the associated subsurface formations). In some cases, a similar process is performed with the available valid logs from the subject well. In this way, aligned logs in terms of gamma-ray and True Vertical Depths (TVDs) are obtained for subsequent processes (e.g., process of understanding an exact position in the ground).

### 2.1 Examples of Missing/Noisy Logs

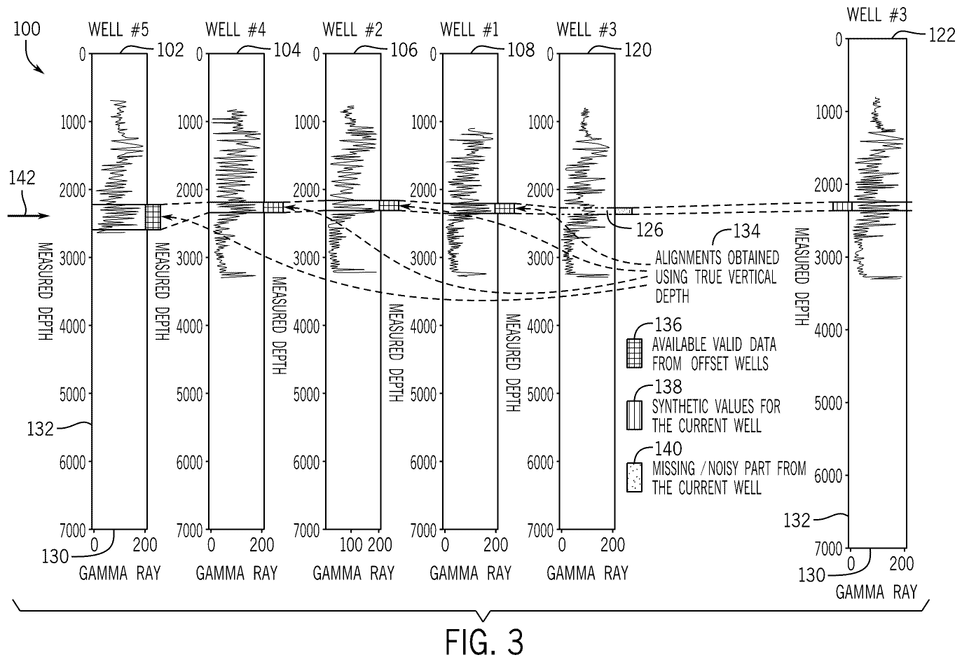

In certain cases, different scenarios of missing/noisy logs may occur. FIG. 3 depicts an example scenario 100 of missing/noisy gamma-ray logs. In this scenario, a gap 126 including a missing or noisy data portion 140 exists between two sections of valid data in a gamma-ray log 120 corresponding to a subject well. After analyzing the missing data portion 140, available valid data 136, such as gamma-ray logs 102, 104, 106, and 108 from the offset wells are selectively arranged (e.g., with respect to a target depth 142) to match different True Vertical Depths Estimated (TVDEs), resulting in alignments 134 using True Vertical Depths (TVD). The selectively arranged gamma-ray logs are then used to estimate gamma-rays corresponding to the particular region (e.g., region around the gap 126) where the missing data portion 140 exits. The estimation may be obtained by using available valid data 136 together with the Measured Depth, the True Vertical Depth (TVD), and mapping the available regional data onto the data missing region after appropriately shrinking or expanding the logs from the offset wells. A gamma-ray log 122 shows synthetic gamma-ray values 138 for the subject well being filled into the gap 126 between two sections of valid data above and below, thereby providing a continuous gamma-ray log plotted with respect to gamma-ray values 130 and Measured Depth 132 for the subject well.

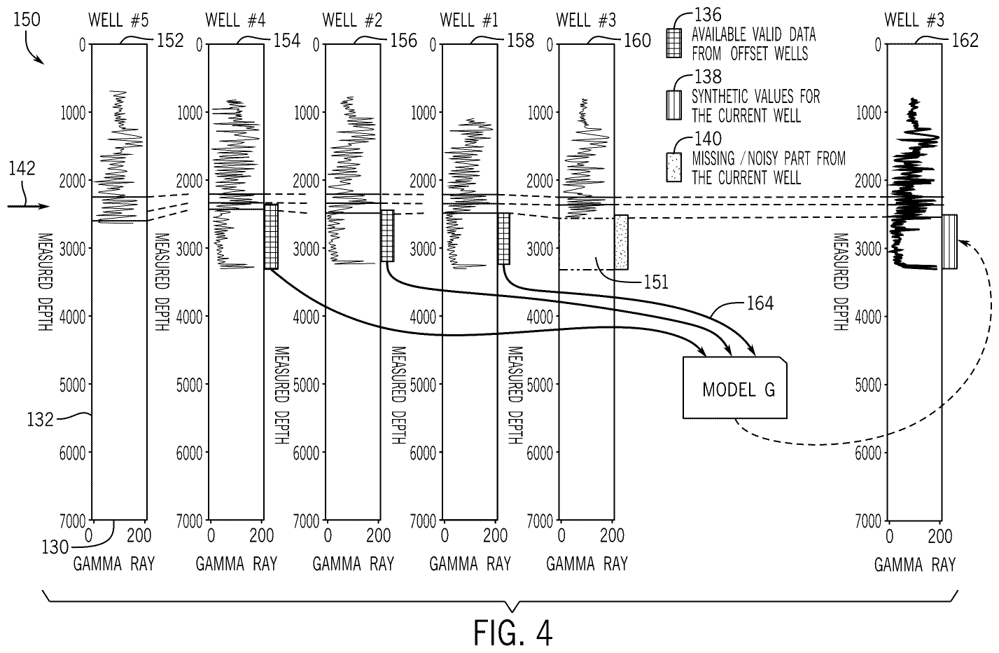

FIG. 4 depicts another example scenario of missing/noisy gamma-ray logs. In this scenario, the missing or noisy logs 140 is continuous in a depth section 151 and has no valid data after the depth section 151. In such a scenario, analysis of the portion of the valid log data available may be conducted to find an alignment of the valid log data. The identified alignment may be used for segregating available valid data 136, such as gamma-ray logs 152, 154, 156, and 158 from the offset wells (i.e., the part of the data from the offset well where the data from the subject well is missing). The segregated valid data 136 may be used as input data (or training data) to train a machine learning model 164 to learn a relationship between the drilling measurements and the gamma-ray values. The trained model may then be used for generating the synthetic gamma-ray values 138 for the subject well.

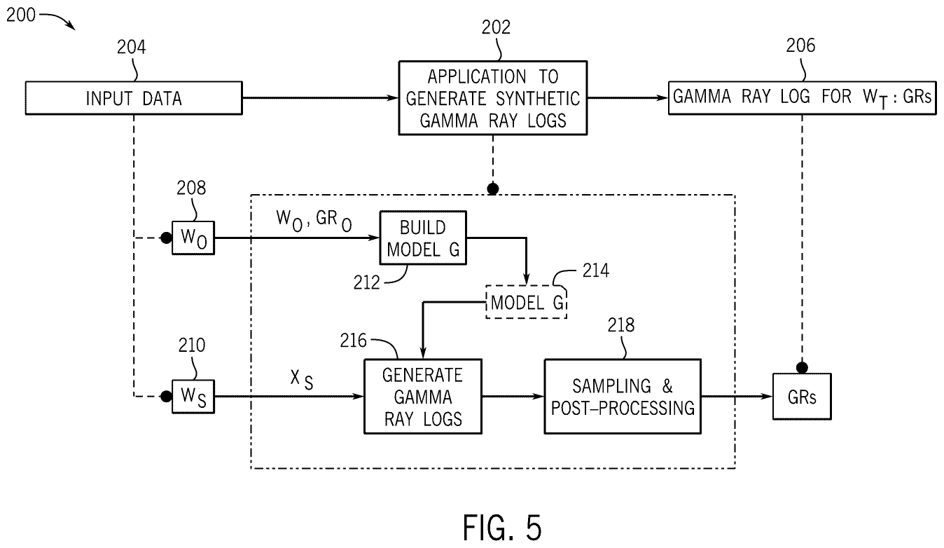

When a gamma-ray measurement device experiences problems, the digital gamma-ray log generation application may allow a user to use the True Vertical Depths Estimated (TVDE) to determine an exact position of a drill bit and hence estimate the subsurface formation, which provide indications in estimating the gamma-ray. The predicted synthetic gamma-ray logs in real-time may provide robustness by having reliable measurement values to substitute the noisy or missing gamma-ray logs due to issues of the logging tools deployed while drilling. Having the framework described above may allow substituting the missing or noisy data with the real-time synthetic data. Additional details with regard to the framework of the digital gamma-ray log generation application will be discussed below with reference to FIGS. 5-7.

### 2.2 PIML Framework (Example 1) Formulation

FIG. 5 depicts an example block diagram of a formulation 200 for gamma-ray log generation using data from the wellsite system 10 of FIG. 1 and the well control system 58 of FIG. 2. The formulation 200 includes an application 202 that uses input data 204 to generate gamma-ray logs (GRₛ) 206 (e.g., predicted synthetic gamma-ray logs). For example, the input data 204 may include offset well data (Wo) 208 associated with a set of offset wells such as offset wells 20A and 20B. The Wo may include a set of drilling parameters (Xₒ) such as data associated with the deploying system 32, a set of gamma-ray logs (GRₒ) such as measured logs from downhole equipment 42, and a set of survey data (Sₒ) such as data measurement from the surface equipment 50 and other systems or components related to the offset wells 20A and 20B.

The input data 204 may also include subject well data (Wₛ) 210 associated with a subject well (or target well) such as the subject well 20C for which the gamma-ray logs are to be generated. The subject well data (Wₛ) 210 may include data received in real-time as the subject well is being drilled. The Wₛ may include a set of drilling parameters (Xₛ) such as data associated with drilling operations in the subject well 20C, and a set of plan data (Pₛ) such as planning the subject well 20C (e.g., initial drilling, plugging, and abandonment).

The application 202 includes a variety of modules, such as a model building module 212, a gamma-ray log generation module 216, and a sampling and post-processing module 218. The model building module 212 may use physics models and machine learning algorithms to build a model (G) 214. The gamma-ray log generation module 216 may use the model (G) 214 to generate the gamma-ray logs (GRₛ) 206 for the subject well 20C. In certain embodiments, the sampling and post-processing module 218 may sampling the gamma-ray logs (GRₛ) 206 (e.g., to match measured gamma-ray logs of the offset wells 20A and 20B in sample rate). In certain embodiments, the sampling and post-processing module 218 may perform other post-processing, such as de-noise, smoothing, and so forth.

In certain cases, the offset well data (Wₒ) 208 from the set of offset wells 20A and 20B may be the only data based on which the model (G) 214 is built for learning (e.g., using machine learning) relationships between surface features and the gamma-rays. In such cases, a performance of the model (G) 214 may depend considerably on the offset well data (Wₒ) 208. Therefore, selecting offset wells that are analogous to the subject well 20C may improve the performance (e.g., accuracy of gamma-ray predictions) of the model (G) 214 being used to generate the gamma-ray logs (GRₛ) 206.

Gamma-ray measurement is a type of geophysical measurement that provides insightful information of subsurface formations in making decisions while drilling. Conventional methods using wireline logs, such as high-resolution acoustic logs, sonic logs, and density logs may include using costly equipment (e.g., sensors) yet may not provide real-time results while drilling. The methods described in the present disclosure provide a complex model capable of predicting the gamma-ray values in real-time while drilling using limited data (e.g., surface drilling measurements) available in real-time. Such a complex model may be helpful to gauge complicated relationships between gamma-ray measurements and subsurface formations in a real-time manner.

For example, the relationships between gamma-ray measurements and subsurface formations may change with different subsurface formations and different regions. Such varied relationships may add extra difficulties in a modeling task (e.g., model building or model evaluation), which may include a single architecture having a set of parameters that may be updated with limited effort using the data from particular offset wells that users may provide. The final model parameters for different sets of offset wells may vary based on the distribution of the offset well data. In certain embodiments, using data (e.g., offset well data (Wₒ) 208) from one or more offset wells (e.g., offset wells 20A and 20B) may facilitate a learning process of a machine learning based model (e.g., model (G) 214) for better understanding the particular relationships, thereby improving the performance (e.g., gamma-ray prediction accuracy and rapidity). During a model building process, selecting particular offset wells (e.g., based on a quality of measured gamma-ray logs from the offset wells) may enhance the performance of the model considerably.

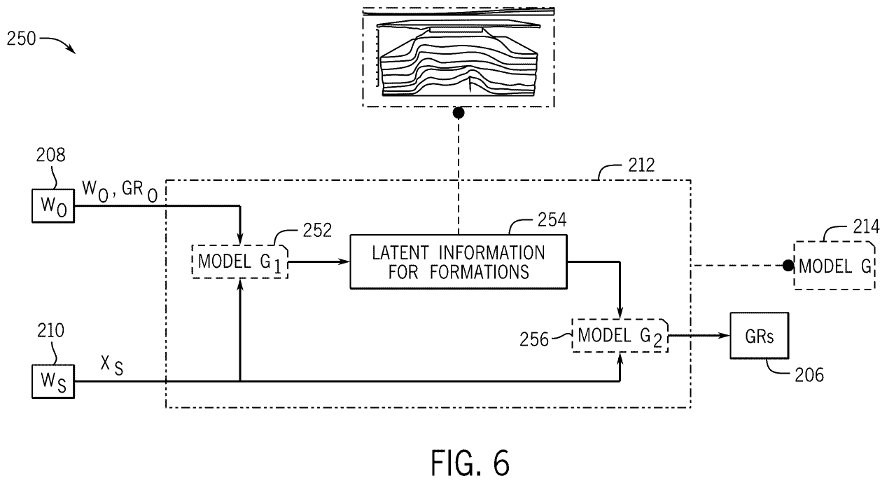

With this in mind, FIG. 6 depicts an example model building process 250 including a two-stage machine learning framework based on the formulation 200 of FIG. 5. The two-stage machine learning framework includes two-staged decomposed machine learning modeling. Based on the context of a problem (e.g., building a model to predict gamma-ray values at a subject well based on limited offset well data), certain objectives of the model building process 250 may include learning a relationship between drilling measurements and the gamma-ray obtained from the offset wells, building a model based on the relationship, and generating (e.g., predicting) the gamma-rays associated with the subject well. The predicted gamma-ray logs may be close to actual gamma-ray logs if performing wireline logging in the subject well.

In certain embodiments, one-shot Machine Learning (ML) models may be used to directly learn the relationship between drilling measurements and the gamma-rays obtained from the offset wells, and then predict the corresponding gamma-rays for the subject well based on drilling measurements from the subject well. For one-shot ML models, a process to learn the relationship between drilling measurements and the subsurface formations (e.g., subsurface formations surrounding the subject well and one or more offset wells) may be implicit. However, in certain embodiments, structures and complexities of the one-shot ML models may be modified and adapted to reflect the different relationships existing in the given data from the different set of offset wells. As a result, such one-shot ML model approaches may not be used directly into an application (e.g., application 202) and put into general use with just retraining a single ML model for processing data from a new set of offset wells that may have different relationships between drilling measurements and measured gamma-rays.

To use and exploit the relationships between subsurface formations and gamma-rays, a model building process (e.g., using the model building module 212) may be decomposed into two stages including a first stage 252 for building a model G1, which may include extracting latent information 254 for the subsurface formations using the surface features (e.g., surface measurements), and a second stage 256 for building a model G2, which may include using the drilling measurements along with the extracted latent information about the subsurface formations (e.g., using the model G1) to predict gamma-ray signal values for the subject well.

As illustrated, a model G (e.g., model (G) 214) may be decomposed into two separated models G1 and G2 with respect to the two stages 252 and 256. This method may enable a user to address the scenarios having changed offset wells in a more efficient way. By utilizing two stages, the model G is compelled to learn the relationship between drilling measurements and subsurface formations, and between the subsurface formations and gamma-ray separately. The two-staged model building may facilitate a process of building the model G to generate the gamma-ray consistent to the subsurface formations of the subject well being drilled. Moreover, because the final gamma-ray predicted by the model G may not only depend on the relationships between surface drilling measurements and offset well gamma-ray logs, the model G may be generalizable and may have the capability of being deployed into applications with just a retraining on the offset wells and no change in the model structure or complexity. Furthermore, two-staged model building may enable the model G to learn the relationship between surface drilling measurements and subsurface formations from historical well logs available and to use certain weights (e.g., based on learning from historical well logs) as a start to retrain the model G.

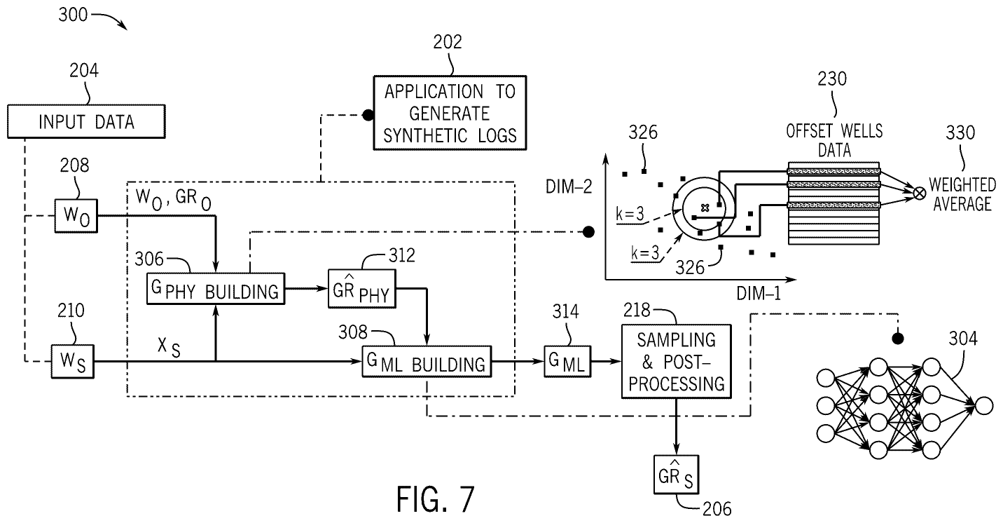

With the foregoing in mid, FIG. 7 depicts an example physics-informed machine learning (PIML) framework for a model training process 300 using the two-stage machine learning framework of FIG. 6. Physics (e.g., physics models) of the process 300 may lay a solid foundation for an implementation of the process 300 (e.g., setting certain rules for the process 300 to abide by). Physical laws that govern the process 300 may be used to design equations that help guide a user through the process 300. Such equations may be derived with the help of experts (e.g., geophysicists, data scientists) to estimate different parameters (e.g., model parameters) with reduced cost and time (e.g., cost and time related to computational resources used to build, train, test, validate, and implement the machine learning based models for generating digital gamma-ray logs).

Data-driven models (e.g., machine learning models) may depend considerably on the data (e.g., training data) from which the models learn. In certain cases, it may be difficult to have models that are generalizable to data points outside the distribution of the training data. Moreover, in certain cases, it may be difficult to generate predictions (e.g., predictions of gamma-ray logs) by such models that abide by the physics laws.

To avoid the process 300 of estimating the parameters (e.g., model parameters) as well as a risk of breaking the physical laws, combined physics models with machine learning models, such as the physics-informed machine learning (PIML) framework described herein, may help to overcome the problems (e.g., lack of generalizable model, predictions not abiding by physics laws) described above.

In certain embodiments, a Physics Guided Neural Network (PGNN) 304 may be used as a part of the model design using the PIML in the process 300. As illustrated in FIG. 7, the application 202 to generate synthetic logs may be decomposed into two modules, a physics model building module 306 and a machine learning model building module 308. Accordingly, a model (e.g., the model (G) 214) may be decomposed into a physics model (G_{PHY}) 312 and a data-driven ML model (G_{ML}) 314. The ML model (G_{ML}) 314 may be used to generate the predicted gamma-ray logs (GRₛ) 206.

In certain cases, it may be difficult to find particular first principles physics models for formulating a problem of generating gamma-ray using surface features (e.g., surface measurements). Alternatively, an empirical representation (e.g., physics model (G_{PHY}) 312) using available data (e.g., offset well data 320) may be used in such cases. The physics model (G_{PHY}) 312 may perform computation based on the data points 326 presented to the model by exploiting various statistical properties of the input data. At this stage, the physics model (G_{PHY}) 312 developed using the input data may be a statistical model and not a machine learning model, and hence may not learn something from the input data. For example, the physics model (G_{PHY}) 312 may only use the given data to generate estimations. The physics model (G_{PHY}) 312 that is free from learning from the data may be adapt to the input data easily and does not need any ‘retraining’.

In certain embodiments, the physics model (G_{PHY}) 312 may be developed using a K-Nearest Neighbors (KNN) algorithm. For example, the physics model (G_{PHY}) 312 using a KNN algorithm may store input data in a memory. When presented with a new data point in a feature space to make predictions, the physics model (G_{PHY}) 312 using a KNN algorithm may compute a distance between the new data point and all the previously stored data points (using different distance functions such as Euclidean distance, Dynamic Time Warping distance, etc.), and identify K nearest neighbors for the new data point (K may be a user-defined parameter). After the K nearest neighbors are identified, the gamma-ray values for the new data point may be predicted based on the gamma-ray readings of these K nearest neighbors. For example, gamma-ray values for the new data point may be computed as a weighted average 330 of the gamma-ray readings of these K nearest neighbors. In certain embodiments, the weights (e.g., weighting factors) may be determined based on the distance of the data points such that the closer the points, the higher the weights. As but one non-limiting example, the distance may be determined using the difference of the depths for the data points. Such calculated weighted average 330 may work as an estimate for the physics model (G_{PHY}) 312.

After generating estimations using the physics model (G_{PHY}) 312, the data-driven ML model (G_{ML}) 314 may be used to generate final estimations with improved accuracy and capability of overcoming any errors caused by the physics model (G_{PHY}) 312. For example, the estimations from the physics model (G_{PHY}) 312 along with the original input data (e.g., subject well data (Wₛ) 210) may be passed through the machine learning model building module 308. The machine learning model building module 308 may output the data-driven ML model (G_{ML}) 314, which may be used to generate the final estimations. The final estimations may pass through the sampling and post-processing module 218 that perform post-processing, such as de-noise, smoothing, and so forth. The post-processed data may include the predicted gamma-ray logs (GRₛ) 206 for the subject well.

Different machine learning algorithms may be used to implement the data-driven ML model (G_{ML}) 276, such as Fully Connected Neural Networks, Accelerated Bayesian Additive Regression Trees (XBART), Extreme Gradient Boosting Trees (XGBoost), and so forth. For example, the XBART algorithm may be used to generate an XBART-based model, which is a modified version of a Bayesian additive regression trees (BART) based model. The BART-based model may be suitable for settings with unstructured predictor variables and substantial sources of unmeasured variation. The XBART-based model may be amenable to fast posterior estimation for predicting gamma-rays. The XGBoost algorithm is a tree-based algorithm, which may sit under the supervised branch of Machine Learning. The XGBoost algorithm may be used for both classification and regression problems.

### 2.3 Predicted GR Logs Based on PIML Framework (Example 1)

As part of a model testing and evaluation process, historically collected data from different wells may be used. For example, using available data indicative of locations of the wells, the historically collected data may be clustered based on well locations and recursively divided into sub-groups. After further analysis (e.g., analyzing the similarity of the nature of the gamma-ray logs), the final sub-group including five wells is obtained, including Well #1, Well #2, Well #3, Well #4, and Well #5. The historically collected data from these five different wells is used to validate the model (e.g., the data-driven ML model (G_{ML}) 276). These five different wells are selected after analyzing the offset well data and determining that these five wells are analogous to each other in the way the gamma-ray has been distributed for them. A Leave-One-Out validation for the five wells is conducted, resulting in four of the five wells that become the offset wells and one of the five wells that becomes the target well.

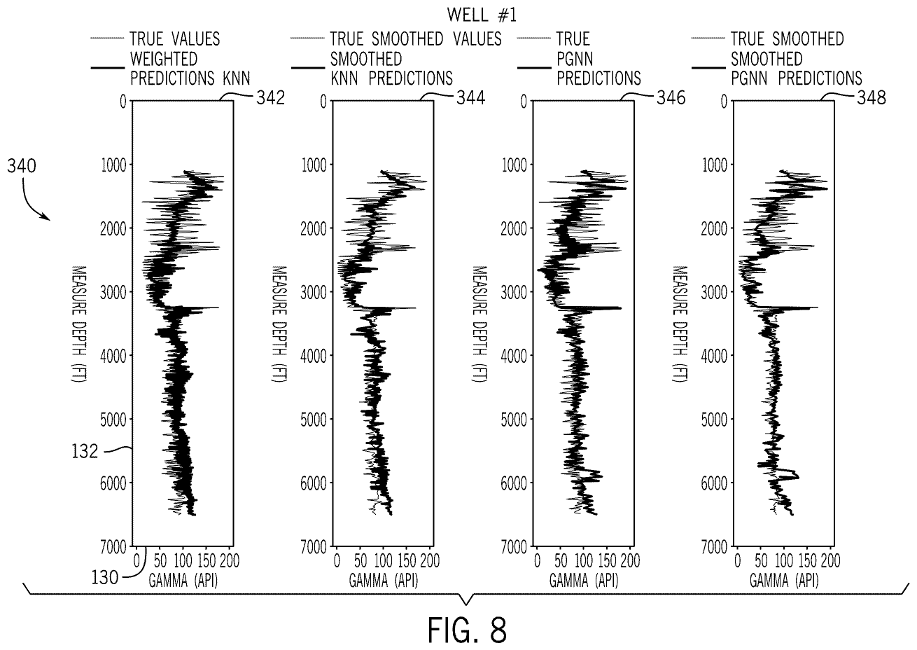

Certain results are illustrated in detail with respect to FIGS. 8-12. These figures depict the results of the predicted gamma-ray (GR) logs plotted as the gamma-ray (GR) value (in API units) versus the measured depth (MD) (in feet). Each figure of FIGS. 8-12 includes four plots corresponding to the same offset well, showing the true and predicted gamma-ray (GR) values using a K-Nearest Neighbors (KNN) algorithm to build the physics model (G_{PHY}) 312, a result of gamma-ray (GR) values after passing the true and predicted gamma-ray values (as shown in the first plot) through a windowed moving average filter for smoothing, a result of the true and predicted gamma-ray (GR) values using the Accelerated Bayesian Additive Regression Trees (XBART) to build the data-driven ML model (G_{ML}) 314, and a result of gamma-ray (GR) values after passing the true and predicted gamma-ray values (in the third plot) through the windowed moving average filter for smoothing, respectively.

For example, FIG. 8 depicts examples of predicted gamma-ray (GR) logs 340 of a first offset well, Well #1, using the physics-informed machine learning (PIML) framework of FIG. 7. A plot 342 shows the true gamma-ray (GR) values (i.e., measured gamma-ray (GR) values) compared to gamma-ray (GR) values using the K-Nearest Neighbors (KNN) algorithm to build the physics model (G_{PHY}) 312. A plot 344 shows the predicted gamma-ray (GR) values after passing the true and predicted gamma-ray values (as shown in the plot 342) through a windowed moving average filter for smoothing. A plot 346 shows the true and predicted gamma-ray (GR) values using the Accelerated Bayesian Additive Regression Trees (XBART) to build the data-driven ML model (G_{ML}) 314. A plot 348 shows the predicted gamma-ray (GR) values after passing the true and predicted gamma-ray values (as shown in the plot 346) through the windowed moving average filter for smoothing. In each plot, the true and predicted gamma-ray (GR) values are plotted as the gamma-ray (GR) value 130 (in API units) versus the measured depth (MD) 132 (in feet).

Based on comparisons, such as the comparison between the true and the predicted gamma-ray values in each of the plots 342-348, the comparisons between the predicted gamma-ray values in plot 342 and 346 (without smoothing), the comparison of the predicted gamma-ray values in plot 344 and 348 (with smoothing), it is evident that the data-driven ML model (G_{ML}) 314 built with the Accelerated Bayesian Additive Regression Trees (XBART) is more capable of matching the trends of the gamma-ray (GR) as indicated in the true gamma-ray values.

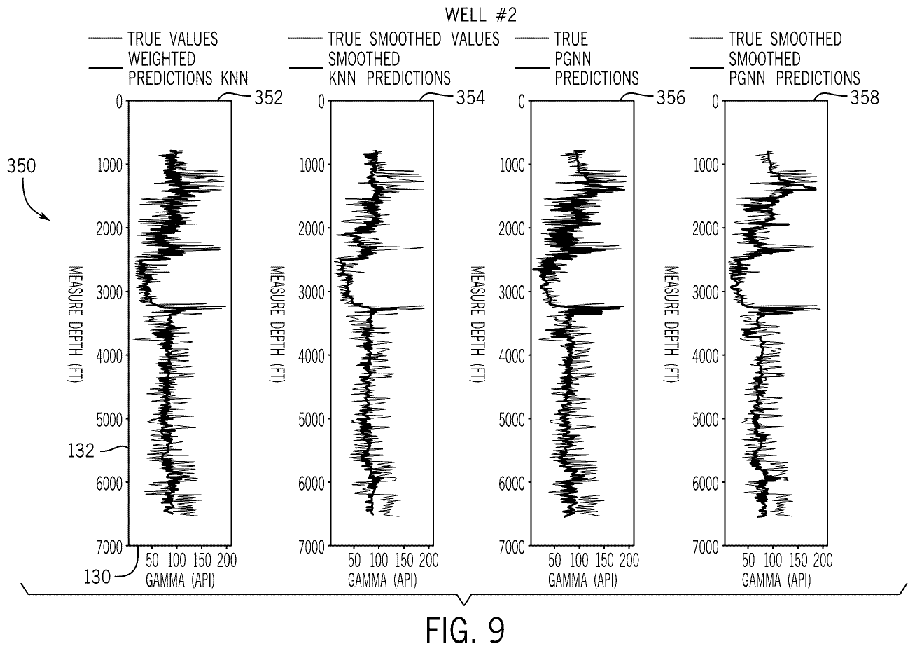

In a similar format as the FIG. 8, FIG. 9 depicts examples of predicted gamma-ray (GR) logs 350 of the second offset well, Well #2, using the physics-informed machine learning (PIML) framework of FIG. 7. A plot 352 shows the true gamma-ray (GR) values (i.e., measured gamma-ray (GR) values) compared to gamma-ray (GR) values using the K-Nearest Neighbors (KNN) algorithm to build the physics model (G_{PHY}) 312. A plot 354 shows the predicted gamma-ray (GR) values after passing the true and predicted gamma-ray values (as shown in the plot 352) through a windowed moving average filter for smoothing. A plot 356 shows the true and predicted gamma-ray (GR) values using the Accelerated Bayesian Additive Regression Trees (XBART) to build the data-driven ML model (G_{ML}) 314. A plot 358 shows the predicted gamma-ray (GR) values after passing the true and predicted gamma-ray values (as shown in the plot 356) through the windowed moving average filter for smoothing. In each plot, the true and predicted gamma-ray (GR) values are plotted as the gamma-ray (GR) value 130 (in API units) versus the measured depth (MD) 132 (in feet).

Based on comparisons, such as the comparison between the true and the predicted gamma-ray values in each of the plots 352-358, the comparisons between the predicted gamma-ray values in plot 352 and 356 (without smoothing), the comparison of the predicted gamma-ray values in plot 354 and 358 (with smoothing), it is evident that the data-driven ML model (G_{ML}) 314 built with the Accelerated Bayesian Additive Regression Trees (XBART) is more capable of matching the trends of the gamma-ray (GR) as indicated in the true gamma-ray values.

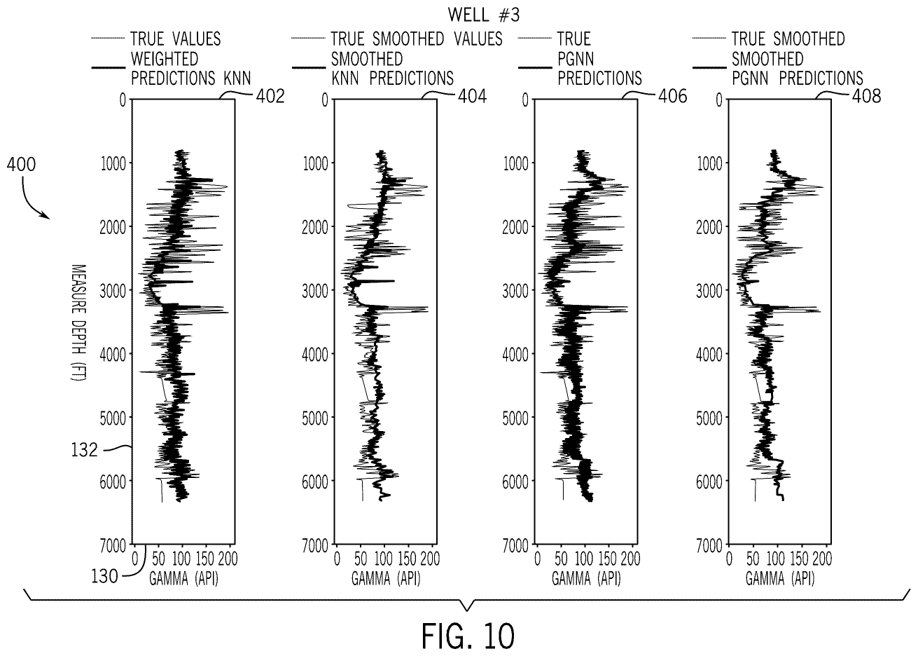

In a similar format as the FIG. 8, FIG. 10 depicts examples of predicted gamma-ray (GR) logs 400 of the third offset well, Well #3, using the physics-informed machine learning (PIML) framework of FIG. 7. A plot 402 shows the true gamma-ray (GR) values (i.e., measured gamma-ray (GR) values) compared to gamma-ray (GR) values using the K-Nearest Neighbors (KNN) algorithm to build the physics model (G_{PHY}) 312. A plot 404 shows the predicted gamma-ray (GR) values after passing the true and predicted gamma-ray values (as shown in the plot 402) through a windowed moving average filter for smoothing. A plot 406 shows the true and predicted gamma-ray (GR) values using the Accelerated Bayesian Additive Regression Trees (XBART) to build the data-driven ML model (G_{ML}) 314. A plot 408 shows the predicted gamma-ray (GR) values after passing the true and predicted gamma-ray values (as shown in the plot 406) through the windowed moving average filter for smoothing. In each plot, the true and predicted gamma-ray (GR) values are plotted as the gamma-ray (GR) value 130 (in API units) versus the measured depth (MD) 132 (in feet).

Based on comparisons, such as the comparison between the true and the predicted gamma-ray values in each of the plots 402-408, the comparisons between the predicted gamma-ray values in plot 402 and 406 (without smoothing), the comparison of the predicted gamma-ray values in plot 404 and 408 (with smoothing), it is evident that the data-driven ML model (G_{ML}) 314 built with the Accelerated Bayesian Additive Regression Trees (XBART) is more capable of matching the trends of the gamma-ray (GR) as indicated in the true gamma-ray values.

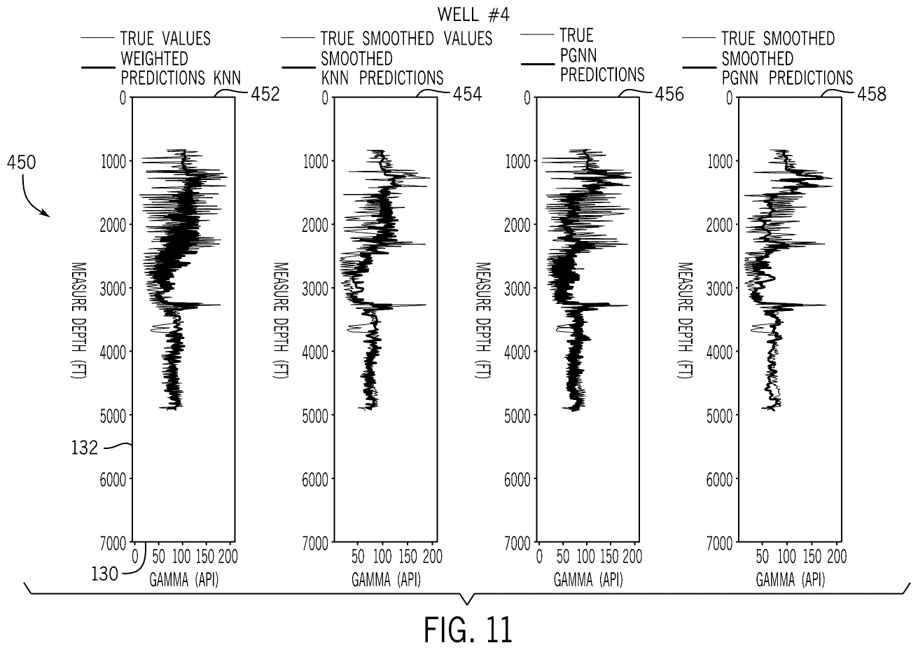

In a similar format as the FIG. 8, FIG. 11 depicts examples of predicted gamma-ray (GR) logs 450 of the fourth offset well, Well #4, using the physics-informed machine learning (PIML) framework of FIG. 7. A plot 452 shows the true gamma-ray (GR) values (i.e., measured gamma-ray (GR) values) compared to gamma-ray (GR) values using the K-Nearest Neighbors (KNN) algorithm to build the physics model (G_{PHY}) 312. A plot 454 shows the predicted gamma-ray (GR) values after passing the true and predicted gamma-ray values (as shown in the plot 452) through a windowed moving average filter for smoothing. A plot 456 shows the true and predicted gamma-ray (GR) values using the Accelerated Bayesian Additive Regression Trees (XBART) to build the data-driven ML model (G_{ML}) 314. A plot 458 shows the predicted gamma-ray (GR) values after passing the true and predicted gamma-ray values (as shown in the plot 456) through the windowed moving average filter for smoothing. In each plot, the true and predicted gamma-ray (GR) values are plotted as the gamma-ray (GR) value 130 (in API units) versus the measured depth (MD) 132 (in feet).

Based on comparisons, such as the comparison between the true and the predicted gamma-ray values in each of the plots 452-458, the comparisons between the predicted gamma-ray values in plot 452 and 456 (without smoothing), the comparison of the predicted gamma-ray values in plot 454 and 458 (with smoothing), it is evident that the data-driven ML model (G_{ML}) 314 built with the Accelerated Bayesian Additive Regression Trees (XBART) is more capable of matching the trends of the gamma-ray (GR) as indicated in the true gamma-ray values.

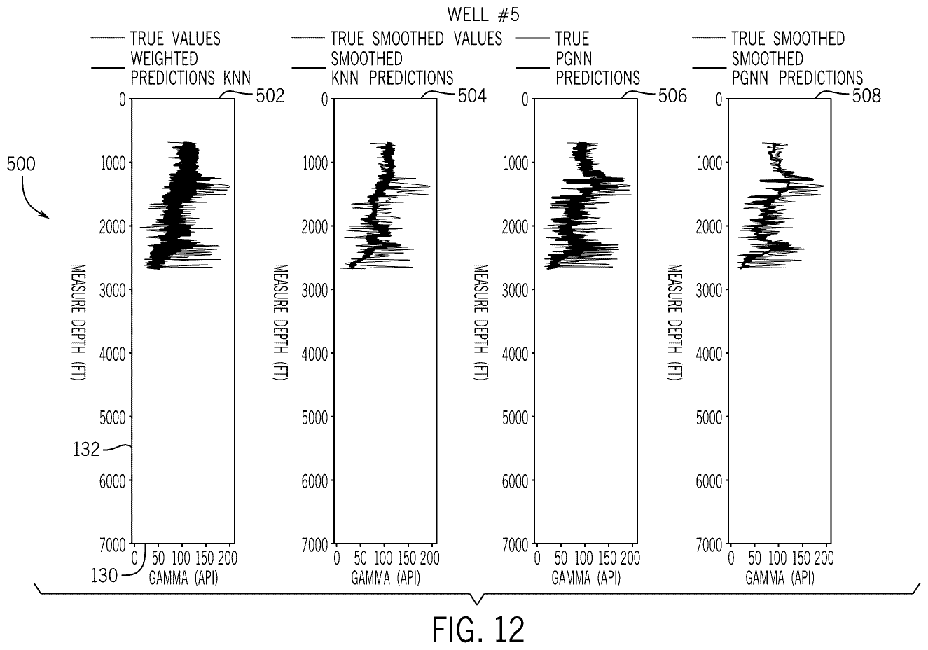

In a similar format as the FIG. 8, FIG. 12 depicts examples of predicted gamma-ray (GR) logs 500 of the fifth offset well, Well #5, using the physics-informed machine learning (PIML) framework of FIG. 7. A plot 502 shows the true gamma-ray (GR) values (i.e., measured gamma-ray (GR) values) compared to gamma-ray (GR) values using the K-Nearest Neighbors (KNN) algorithm to build the physics model (G_{PHY}) 312. A plot 504 shows the predicted gamma-ray (GR) values after passing the true and predicted gamma-ray values (as shown in the plot 502) through a windowed moving average filter for smoothing. A plot 506 shows the true and predicted gamma-ray (GR) values using the Accelerated Bayesian Additive Regression Trees (XBART) to build the data-driven ML model (G_{ML}) 314. A plot 508 shows the predicted gamma-ray (GR) values after passing the true and predicted gamma-ray values (as shown in the plot 506) through the windowed moving average filter for smoothing. In each plot, the true and predicted gamma-ray (GR) values are plotted as the gamma-ray (GR) value 130 (in API units) versus the measured depth (MD) 132 (in feet).

Based on comparisons, such as the comparison between the true and the predicted gamma-ray values in each of the plots 502-508, the comparisons between the predicted gamma-ray values in plot 502 and 506 (without smoothing), the comparison of the predicted gamma-ray values in plot 504 and 508 (with smoothing), it is evident that the data-driven ML model (G_{ML}) 314 built with the Accelerated Bayesian Additive Regression Trees (XBART) is more capable of matching the trends of the gamma-ray (GR) as indicated in the true gamma-ray values.

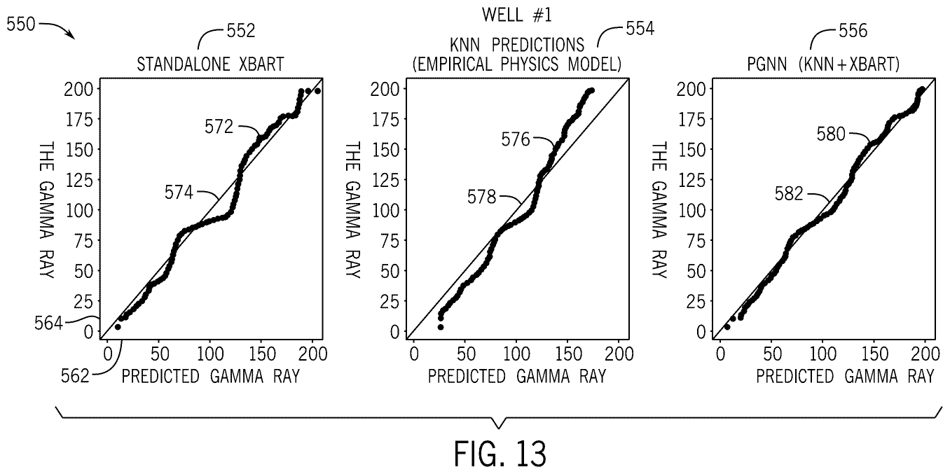

For further analysis of the predicted gamma-rays using different algorithms for model building, such as an error analysis based on the predicted gamma-ray showing in FIGS. 8-12, a QQ plot (quantile-quantile plot) is used to analyze the errors corresponding to different model building processes. In statistics, the QQ plot is a probability plot using a graphical method for comparing two probability distributions by plotting their quantiles against each other. FIGS. 13-17 depict QQ plots (quantile-quantile plots) corresponding to different offset wells (e.g., Well #1, Well #2, Well #3, Well #4, and Well #5) with different model building processes (e.g., using standalone Accelerated Bayesian Additive Regression Trees (XBART), using the K-Nearest Neighbors (KNN) algorithm, and using the Physics Guided Neural Network (PGNN) algorithm). Each QQ plot shows the predicted gamma-ray (GR) value (with respect to an axis 562 in API units) versus the true gamma-ray (GR) value (with respect to an axis 564 in API units).

For example, FIG. 13 depicts QQ plots (quantile-quantile plots) 550 corresponding to the first offset well, Well #1 and showing the predicted gamma-ray (GR) values using different algorithms for model building versus the true gamma-ray (GR). For example, a first plot 552 shows the predicted gamma-ray (GR) values 572 using the standalone Accelerated Bayesian Additive Regression Trees (XBART) versus the true gamma-ray (GR) values 574. A second plot 554 shows the predicted gamma-ray (GR) values 576 using the K-Nearest Neighbors (KNN) algorithm (i.e., the empirical physics model) versus the true gamma-ray (GR) values 578. A third plot 556 shows the predicted gamma-ray (GR) values 580 using the Physics Guided Neural Network (PGNN) algorithm (i.e., KNN plus XBART) versus the true gamma-ray (GR) values 582, respectively.

Based on comparisons, such as the comparison between the predicted gamma-ray (GR) values 572 and the true gamma-ray (GR) values 574 as shown in the first plot 552, the comparison between the predicted gamma-ray (GR) values 576 and the true gamma-ray (GR) values 578 as shown in the second plot 554, the comparison between the predicted gamma-ray (GR) values 580 and the true gamma-ray (GR) values 582 as shown in the third plot 556, it is evident from the plots that the predicted gamma-ray values from models built with the XBART algorithm, with the KNN algorithm, and with the PGNN algorithm, respectively, are capable of matching the true gamma-ray (GR) values, thereby validating the effectiveness of these model building algorithms.

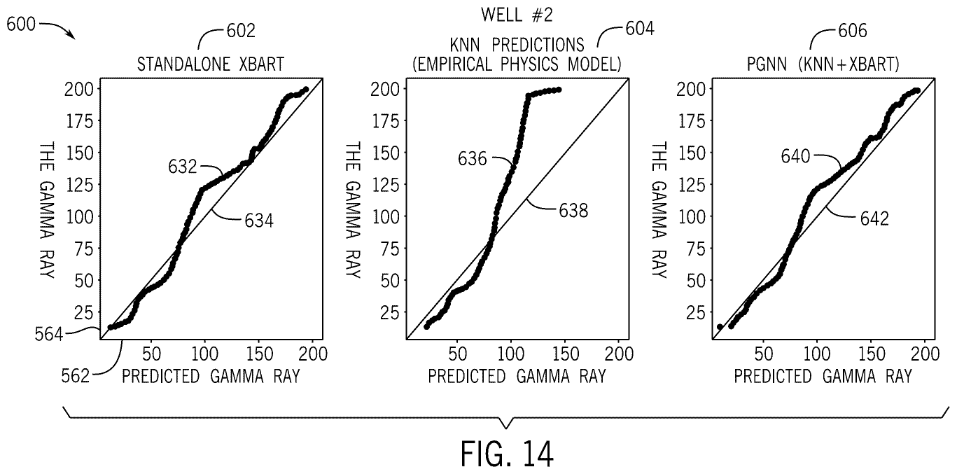

In a similar format as the FIG. 13, FIG. 14 depicts QQ plots (quantile-quantile plots) 600 corresponding to the second offset well, Well #2 and showing the predicted gamma-ray (GR) values using different algorithms for model building versus the true gamma-ray (GR). For example, a first plot 602 shows the predicted gamma-ray (GR) values 632 using the standalone Accelerated Bayesian Additive Regression Trees (XBART) versus the true gamma-ray (GR) values 634. A second plot 604 shows the predicted gamma-ray (GR) values 636 using the K-Nearest Neighbors (KNN) algorithm (i.e., the empirical physics model) versus the true gamma-ray (GR) values 638. A third plot 606 shows the predicted gamma-ray (GR) values 640 using the Physics Guided Neural Network (PGNN) algorithm (i.e., KNN plus XBART) versus the true gamma-ray (GR) values 642, respectively.

Based on comparisons, such as the comparison between the predicted gamma-ray (GR) values 632 and the true gamma-ray (GR) values 634 as shown in the first plot 602, the comparison between the predicted gamma-ray (GR) values 636 and the true gamma-ray (GR) values 638 as shown in the second plot 604, the comparison between the predicted gamma-ray (GR) values 640 and the true gamma-ray (GR) values 642 as shown in the third plot 606, it is evident from the plots that the predicted gamma-ray values from models built with the XBART algorithm, with the KNN algorithm, and with the PGNN algorithm, respectively, are capable of matching the true gamma-ray (GR) values, thereby validating the effectiveness of these model building algorithms.

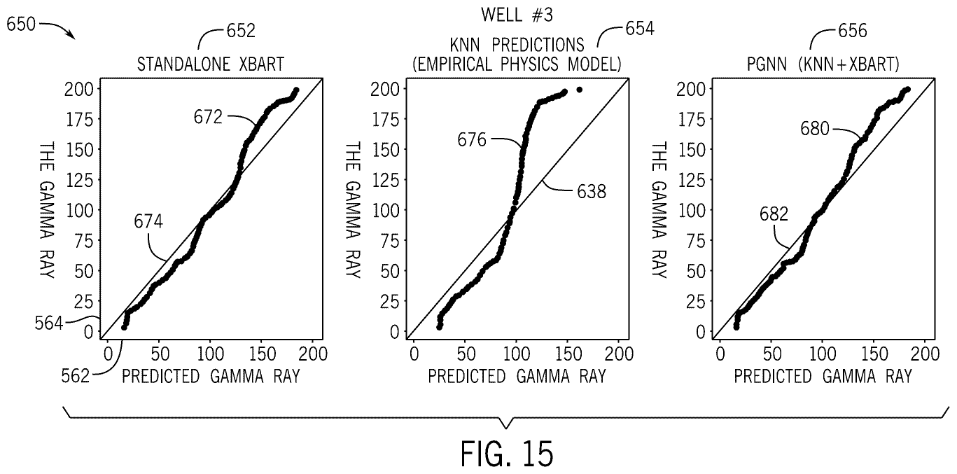

In a similar format as the FIG. 13, FIG. 15 depicts QQ plots (quantile-quantile plots) 650 corresponding to the third offset well, Well #3 and showing the predicted gamma-ray (GR) values using different algorithms for model building versus the true gamma-ray (GR). For example, a first plot 652 shows the predicted gamma-ray (GR) values 672 using the standalone Accelerated Bayesian Additive Regression Trees (XBART) versus the true gamma-ray (GR) values 674. A second plot 654 shows the predicted gamma-ray (GR) values 676 using the K-Nearest Neighbors (KNN) algorithm (i.e., the empirical physics model) versus the true gamma-ray (GR) values 678. A third plot 656 shows the predicted gamma-ray (GR) values 680 using the Physics Guided Neural Network (PGNN) algorithm (i.e., KNN plus XBART) versus the true gamma-ray (GR) values 682, respectively.

Based on comparisons, such as the comparison between the predicted gamma-ray (GR) values 672 and the true gamma-ray (GR) values 674 as shown in the first plot 652, the comparison between the predicted gamma-ray (GR) values 676 and the true gamma-ray (GR) values 678 as shown in the second plot 654, the comparison between the predicted gamma-ray (GR) values 680 and the true gamma-ray (GR) values 682 as shown in the third plot 656, it is evident from the plots that the predicted gamma-ray values from models built with the XBART algorithm, with the KNN algorithm, and with the PGNN algorithm, respectively, are capable of matching the true gamma-ray (GR) values, thereby validating the effectiveness of these model building algorithms.

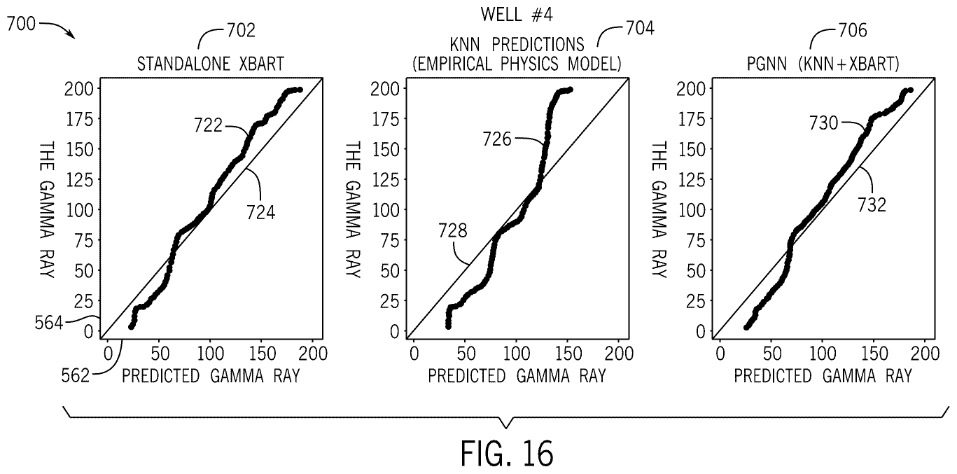

In a similar format as the FIG. 13, FIG. 16 depicts QQ plots (quantile-quantile plots) 700 corresponding to the fourth offset well, Well #4 and showing the predicted gamma-ray (GR) values using different algorithms for model building versus the true gamma-ray (GR). For example, a first plot 702 shows the predicted gamma-ray (GR) values 722 using the standalone Accelerated Bayesian Additive Regression Trees (XBART) versus the true gamma-ray (GR) values 724. A second plot 704 shows the predicted gamma-ray (GR) values 726 using the K-Nearest Neighbors (KNN) algorithm (i.e., the empirical physics model) versus the true gamma-ray (GR) values 728. A third plot 706 shows the predicted gamma-ray (GR) values 730 using the Physics Guided Neural Network (PGNN) algorithm (i.e., KNN plus XBART) versus the true gamma-ray (GR) values 732, respectively.

Based on comparisons, such as the comparison between the predicted gamma-ray (GR) values 722 and the true gamma-ray (GR) values 724 as shown in the first plot 702, the comparison between the predicted gamma-ray (GR) values 726 and the true gamma-ray (GR) values 728 as shown in the second plot 704, the comparison between the predicted gamma-ray (GR) values 730 and the true gamma-ray (GR) values 732 as shown in the third plot 706, it is evident from the plots that the predicted gamma-ray values from models built with the XBART algorithm, with the KNN algorithm, and with the PGNN algorithm, respectively, are capable of matching the true gamma-ray (GR) values, thereby validating the effectiveness of these model building algorithms.

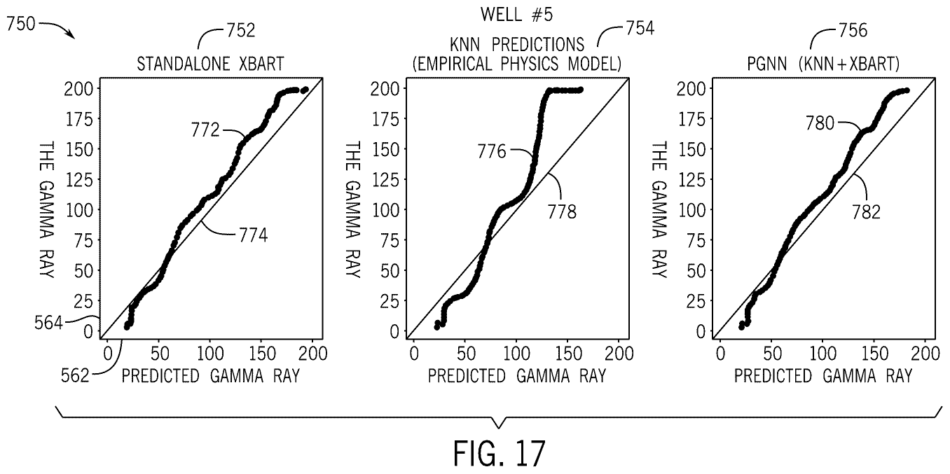

In a similar format as the FIG. 13, FIG. 17 depicts QQ plots (quantile-quantile plots) 750 corresponding to the fifth offset well, Well #5 and showing the predicted gamma-ray (GR) values using different algorithms for model building versus the true gamma-ray (GR). For example, a first plot 752 shows the predicted gamma-ray (GR) values 772 using the standalone Accelerated Bayesian Additive Regression Trees (XBART) versus the true gamma-ray (GR) values 774. A second plot 754 shows the predicted gamma-ray (GR) values 776 using the K-Nearest Neighbors (KNN) algorithm (i.e., the empirical physics model) versus the true gamma-ray (GR) values 778. A third plot 756 shows the predicted gamma-ray (GR) values 780 using the Physics Guided Neural Network (PGNN) algorithm (i.e., KNN plus XBART) versus the true gamma-ray (GR) values 782, respectively.

Based on comparisons, such as the comparison between the predicted gamma-ray (GR) values 772 and the true gamma-ray (GR) values 774 as shown in the first plot 752, the comparison between the predicted gamma-ray (GR) values 776 and the true gamma-ray (GR) values 778 as shown in the second plot 754, the comparison between the predicted gamma-ray (GR) values 780 and the true gamma-ray (GR) values 782 as shown in the third plot 756, it is evident from the plots that the predicted gamma-ray values from models built with the XBART algorithm, with the KNN algorithm, and with the PGNN algorithm, respectively, are capable of matching the true gamma-ray (GR) values, thereby validating the effectiveness of these model building algorithms.

The predicted gamma-ray values in FIGS. 8-12 and the error analysis based on the predicted gamma-ray values in FIGS. 3-17 provide evidence indicating that the physics-informed machine learning (PIML) framework in the process 300 is capable of predicting the trends of the gamma-ray logs with desired accuracy and may be useful for users (e.g., geoscientists) to make the preliminary analysis of how the subsurface formations are distributed under the location where the subject well is being developed. Moreover, the predicted gamma-ray logs may be useful for other users (e.g., drillers) to determine a progress in a drilling process.

### Section 3 Automated Formation Information Extraction

Information of formations (e.g., subsurface rock formations) in an area where a subject well is drilling are important to a well development process (e.g., well construction). The information of the formations is also important to build various models (e.g., physics models, machine learning models) to facilitate the well development process. For example, during the model building within the physics-informed machine learning (PIML) framework described above, certain information (e.g., the latent information 254) may be extracted for the subsurface rock formations using the surface features (e.g., surface measurements). As another example, during model testing and evaluation process, historically collected data from different wells may be clustered and recursively divided into sub-groups based on well locations, and then used for validating developed models (e.g., physics model (G_{PHY}) 312, data-driven ML model (G_{ML}) 314).

However, given the varying types of formations, the formation information may not be available as a ground truth established across a particular region, therefore creating challenges for the well development process. For example, users (e.g., geologists, geophysicists, and so forth) often use gamma-ray logs and other relevant logs for determining and/or differentiating one formation from the other. Depending on the time and requirements, the users may adjust formation information they look for while assigning formation labels to a particular section. Depending on the knowledge of a user who is looking at data (e.g., gamma-ray logs), the assignments of the formation labels may not be the same as the other users, thereby resulting in a varying set of assignments for the same data.

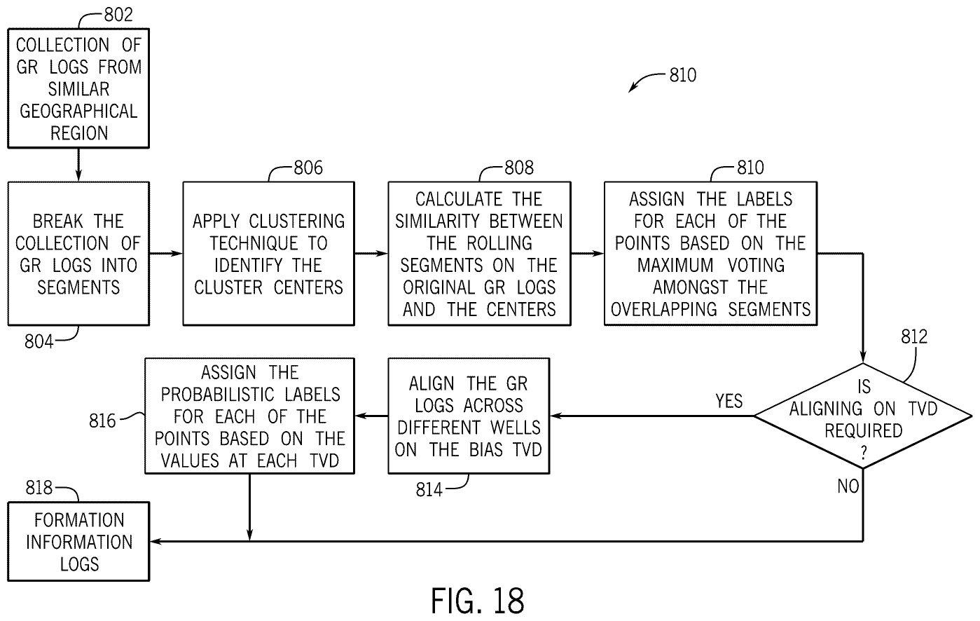

To overcome the challenges described above, a method described below with respect to FIGS. 18-23 provide solutions to automatically identify the formations by analyzing the gamma-ray readings obtained from logging tools (e.g., logging while drilling (LWD) tools, measuring while drilling (MWD) tools, and so forth). This method may allow users (e.g., oil and gas operators) to have an initial set of assignments that are adjustable based on formation details used for particular tasks. Based on the assignments, information about a formation (e.g., formation tops) may be extracted. The extracted information may help provide the users with prior information in form of formation labels representing formation types to kickstart applications (e.g., application 202 for generating synthetic gamma-ray logs) that depend on formation information. In particular, the extracted information may be useful for providing the prior information about the formation for real-time data-driven models (e.g. data-driven ML model (G_{ML}) 314). Additionally, or alternatively, the extracted information may serve as an additional service along with existing services for providing guidance for the other users (e.g., geoscientists) in tasks such as formation evaluations. In certain embodiments, the extracted information may be embedded into a dashboard that may serve as a guide to the other users who may be involved in formation labeling tasks (e.g., marking the formation tops).

Formation tops used herein may be referred to as an integral part of the decision-making in any type of drilling processes. The gamma-ray characterizes the formations and helps users to better understand properties of various rocks that constitute the formations. Analyzing the gamma-ray logs, such as identifying troughs and crests, as well as the patterns in the gamma-ray logs may deepen the understanding of changes in formations and the formation tops.

The methods described herein also uses time series clustering method that allows users to cluster (group) similar shaped time series elements. The time series clustering may be similar to the process of analyzing patterns, troughs, and crests of a time series signal. The time series clustering method described herein may provide an automated process for identifying the formation information. For example, the time series clustering method may allow users to specify several algorithmic parameters, such as the number of gamma-ray points to be used, for analyzing the gamma-ray readings, as well as a stride between two analysis windows. Based on the specified algorithmic parameters, a single gamma-ray log may be broken down into multiple different parts upon which the time series clustering may be applied to group the multiple parts of the gamma-ray log into clusters, where each cluster may have a unique shape. Once the groupings are obtained, the method may allow the users to identify a center (e.g., mean representation) for each cluster and to use the identified centers to align the multiple parts back to a single gamma-ray log. As such, the method may allow the users to have a set of labels for a particular point in depth. In certain cases, the number of labels for a particular point depends on the number of overlapping signals decided by a specified size of the area and the stride. Once the set of labels for all the points in depth are obtained, a majority voting scheme based on overlapping segments may be used and the value of the label corresponding to the maximum votes may be used as the final label for the particular point.

In certain embodiments, the method described herein may allow the users to use certain prior knowledge (e.g., knowledge of a basin where the gamma-ray logs corresponding to the different well are drilled) to align the formations. For example, users may align the formations based on the values of different trajectory based parameters such as the True Vertical Depth (TVD). In such cases, the method may allow a user to use the same setting to cluster different gamma-ray segments on multiple wells and obtain formation information for each well individually. Moreover, after obtaining the formation information, an additional alignment of the formations may be performed based on an additional round of voting that is done across the wells, generating a set of probabilistic labels signifying the alignment of the labels representing the formations across each of the wells based on the TVD values.

In certain embodiments, the method described herein may analyze the labels generated for each particular point (in depth) and the groups of wells formed, allowing the users to mark the formation tops and obtain the depth information in terms of the Measured Depth (MD) and True Vertical Depth (TVD). The depth information may serve as a starting point for guiding the users to label the formations. Moreover, the method described herein may provide a way to use the real-time information (e.g., in the form of the drilling measurements) in conjunction with an automated formation extraction tool to determine the formation information of the subject well being drilled. The real-time information may also be used in software design and improvement for real-time automation software applications that may benefit from the knowledge of the formation types/tops.

With the forgoing in mind, FIG. 18 depicts an example flow diagram of a method 800 for extraction of formation information. In certain embodiments, a computing system, such as the logging and control system 56, the computing system 76, other computing system(s) in the cloud computing 74, and so forth, may perform operations described herein via one or more processors (e.g., the processor 62 based on processor-executable code stored in the storage media 64). Although the method 800 described in FIG. 18 is described in a particular order, it should be noted that the method 800 may be performed in any suitable order and is not limited to the order presented herein.

Referring now to FIG. 18, at process block 802, computing system collects gamma-ray logs from offset wells (e.g., offset wells 20A and 20B). In certain embodiments, the computing system may control the downhole equipment 42 including the logging tools 22 to detect naturally occurring gamma radiation emitted from certain substances (e.g., potassium, radioactive minerals) embedded in the subsurface formations (e.g., the geological formation 14) and generate the gamma-ray logs. The computing system may store the gamma-ray logs locally (e.g., in the storage media 64) that may be processed (e.g., by the processors 62) for subsequent processes (e.g., model building, latent information extraction, model testing and/or validation, gamma-ray generation for the subject well 20C, and so forth). In certain cases, the gamma-ray logs may be stored in a remote location (e.g., cloud) and processed by the cloud computing 74 and/or the computing system 76 communicatively coupled to the cloud computing 74.

At process block 804, the computing system breaks the collected gamma-ray logs into segments. For example, the computing system may use certain gamma-ray tools (e.g., spectral gamma-ray tool) to break down or segment the detected gamma-ray readings based on certain criteria (e.g., different energies) using spectral analysis techniques. The segments may correspond to certain radioactive families of the substances (e.g., potassium, uranium, and thorium). The use of the spectral gamma-ray tool may allow removal of gamma-ray counts caused by certain unwanted substances (e.g., uranium), thereby enabling more accurate use of the remaining gamma-rays for determining lithology, volume shale, volume clay, and so forth.

At process block 806, the computing system applies clustering techniques to identify the cluster centers. For example, based on certain parameters (e.g., specified algorithmic parameters), a single gamma-ray log may be broken down into multiple different parts. A time series clustering may be applied to group the multiple parts of the gamma-ray log into clusters, where each cluster may have a unique shape. After groupings group the multiple parts of the gamma-ray log into clusters, the computing system may identify a center (e.g., mean representation) for each cluster.

At process block 808, the computing system calculates the similarities between rolling segments on the original gamma-ray log and the center. Furthermore, at process block 810, the computing system assigns a set of labels for each particular points in depth. In certain cases, the number of labels for a particular point depends on a number of overlapping signals decided by a specified size of the area and the stride.

After the set of labels for all the points in depth are obtained, at process block 810, the computing system assigns the set of labels for each of the particular points based on a maximum voting among the overlapping segments. For example, a majority voting scheme based on overlapping segments may be used and the value of the label corresponding to the maximum votes may be used as the final label for the particular point.

At process block 812, the computing system determines whether an alignment on the True Vertical Depth (TVD) is needed. If determining that the alignment on the TVD is needed, at process block 814, the computing system aligns the gamma-ray logs across different offset wells based on the TVD. For example, certain prior knowledge (e.g., knowledge of a basin where the gamma-ray logs corresponding to different wells are drilled) may be used to align the gamma-ray logs across different offset wells. In such cases, the computing system may use the same setting to cluster different gamma-ray segments on multiple wells and obtain an alignment for each well individually.

In certain embodiments, one or more additional alignment may be applied to the gamma-ray logs after aligning the gamma-ray logs at process block 814. For example, the computing system may perform an additional alignment based on an additional round of voting that is done across the wells and generate a set of probabilistic labels signifying the alignment of the labels representing the formations across each of the wells based on the TVD values. At process block 816, the computing system assigns the probabilistic labels for each of the particular points based on the values at each TVD.

At process block 818, the computing system generates formation information logs based on the aligned gamma-ray logs and the probabilistic labels assigned to the particular points in depth. For example, the computing system may allow users to analyze the labels generated for each particular point in depth and the grouped offset wells, mark the formation tops, and obtain the depth information in terms of the Measured Depth (MD) and True Vertical Depth (TVD). The depth information may serve as a starting point for guiding the users to label the formations. Moreover, the computing system may provide a way to use the real-time information (e.g., in the form of the drilling measurements) in conjunction with an automated formation extraction tool to determine the formation information of the subject well being drilled.

If determining that the alignment on the TVD is not needed (at the process block 812), the computing system may directly generate formation information logs based on the aligned gamma-ray logs and the probabilistic labels assigned to the particular points in depth, as described above at process block 818.

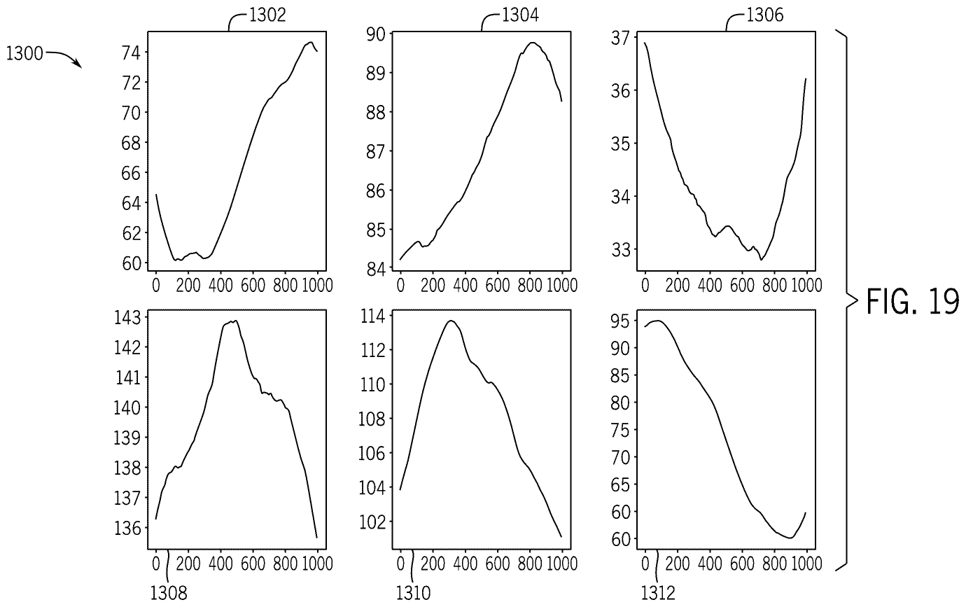

The method 800 described above may be tested using different sets of wells to validate the generalizability of the method 800. Certain test results are presented in following sections with respect to FIGS. 19-23.

FIG. 19 depicts example plots showing test results for evaluating the process of FIG. 18 for extraction of formation information. Each of the six example plots 1302-1308 depicts a barycenter of clusters that may define different subsurface formations. As mentioned previously, the clusters may be formed by grouping multiple parts of a given gamma-ray log. Each cluster may have a unique shape and each shape may define different formations.

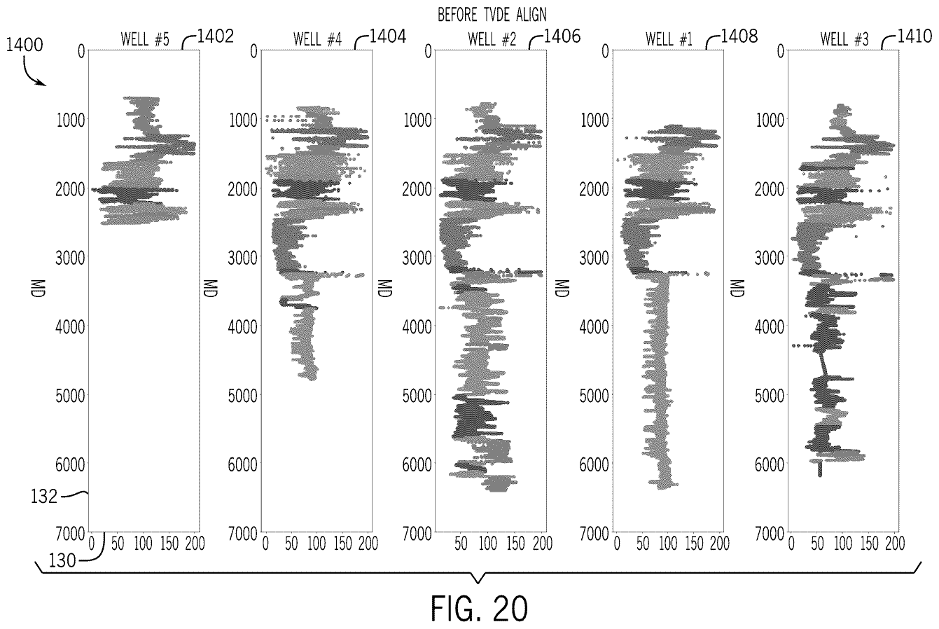

FIGS. 20-23 depict certain different sets of example gamma-ray logs output from the method 800 of FIG. 18 before and after a True Vertical Depths Estimated (TVDE) alignment indexed on the measured depth (MD) and True Vertical Depths Estimated, respectively.

For example, FIG. 20 depicts a fist set of example gamma-ray logs 1380 output from the method 800 of FIG. 18 before the True Vertical Depths Estimated (TVDE) alignment. Each example gamma-ray log corresponds to an offset well and the gamma-ray values are plotted as the gamma-ray (GR) value 130 (in API units) versus the measured depth (MD) 132 (in feet). For example, plots 1382, 1384, 1386, 1388, and 1410 depict the output gamma-ray logs before the TVDE alignment from the method 800 corresponding to different offset wells, including Well #5, Well #4, Well #2, Well #1, and Well #3). The results depicted in FIG. 20 signify the labels for the extracted formations for different offset wells before the TVDE alignment. Different colored log sections correspond to different formation types and an opacity of each point represents the probabilistic natures of a corresponding label.

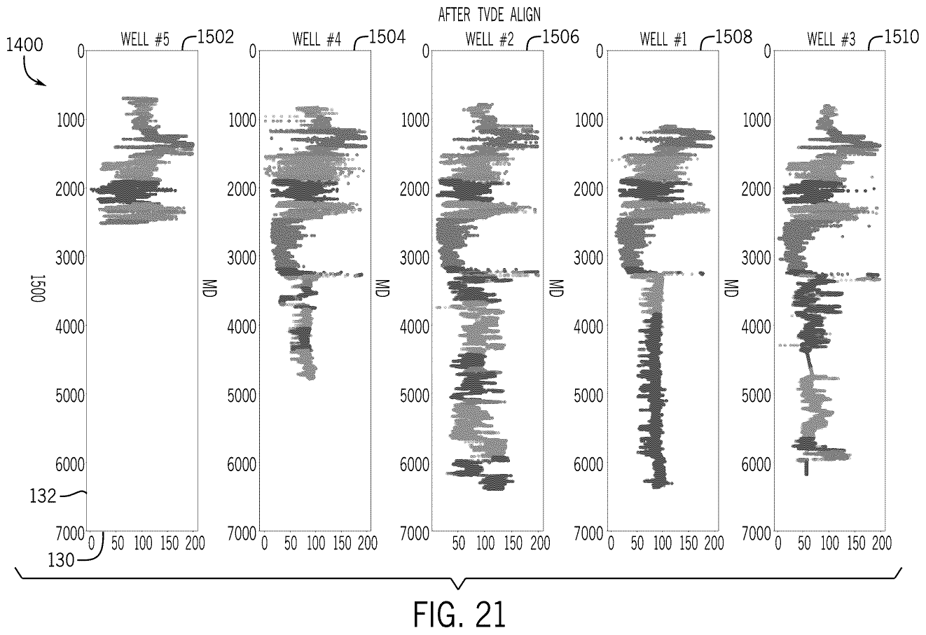

In a similar format as FIG. 20, FIG. 21 depicts the first set of example gamma-ray logs 1380 output from the method 800 of FIG. 18 after the True Vertical Depths Estimated (TVDE) alignment. Each example gamma-ray log corresponds to an offset well and the gamma-ray values are plotted as the gamma-ray (GR) value 130 (in API units) versus the measured depth (MD) 132 (in feet). For example, plots 1502, 1504, 1506, 1508, and 1510 depict the output gamma-ray logs after the TVDE alignment from the method 800 corresponding to different offset wells, including Well #5, Well #4, Well #2, Well #1, and Well #3). The results depicted in FIG. 21 signify the labels for the extracted formations for different offset wells after the TVDE alignment. Different colored log sections correspond to different formation types and an opacity of each point represents the probabilistic natures of a corresponding label.

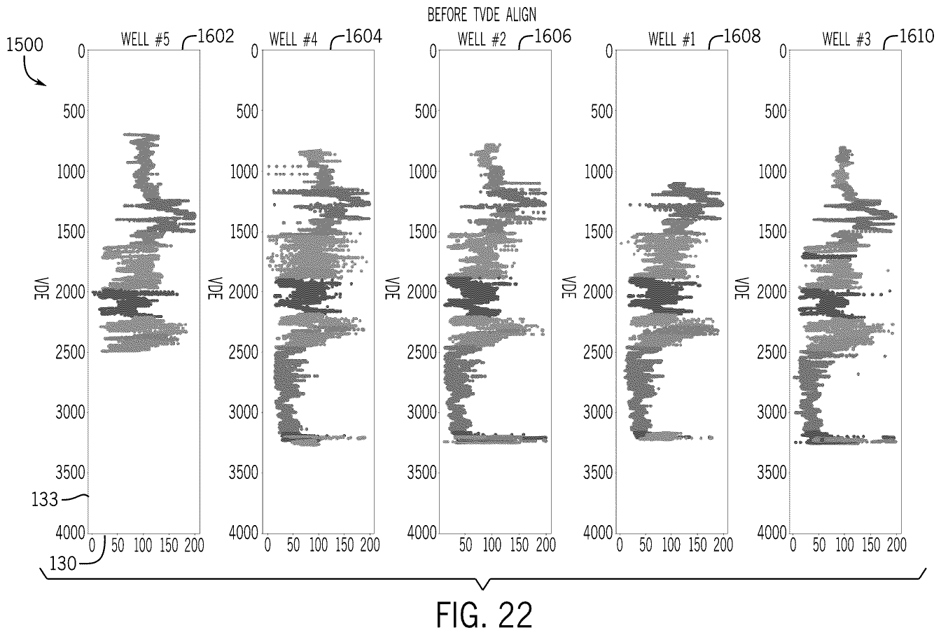

FIG. 22 depicts a second set of example gamma-ray logs 1500 (covering a different depth range from the first set of example gamma-ray logs 1380 of FIGS. 20-21) output from the method 800 of FIG. 18 before the True Vertical Depths Estimated (TVDE) alignment. Each example gamma-ray log corresponds to an offset well and the gamma-ray values are plotted as the gamma-ray (GR) value 130 (in API units) versus the True Vertical Depths Estimated (TVDE) 133 (in feet). For example, plots 1382, 1384, 1386, 1388, and 1410 depict the output gamma-ray logs before the TVDE alignment from the method 800 corresponding to different offset wells, including Well #5, Well #4, Well #2, Well #1, and Well #3). The results depicted in FIG. 22 signify the labels for the extracted formations for different offset wells before the TVDE alignment. Different colored log sections correspond to different formation types and an opacity of each point represents the probabilistic natures of a corresponding label.

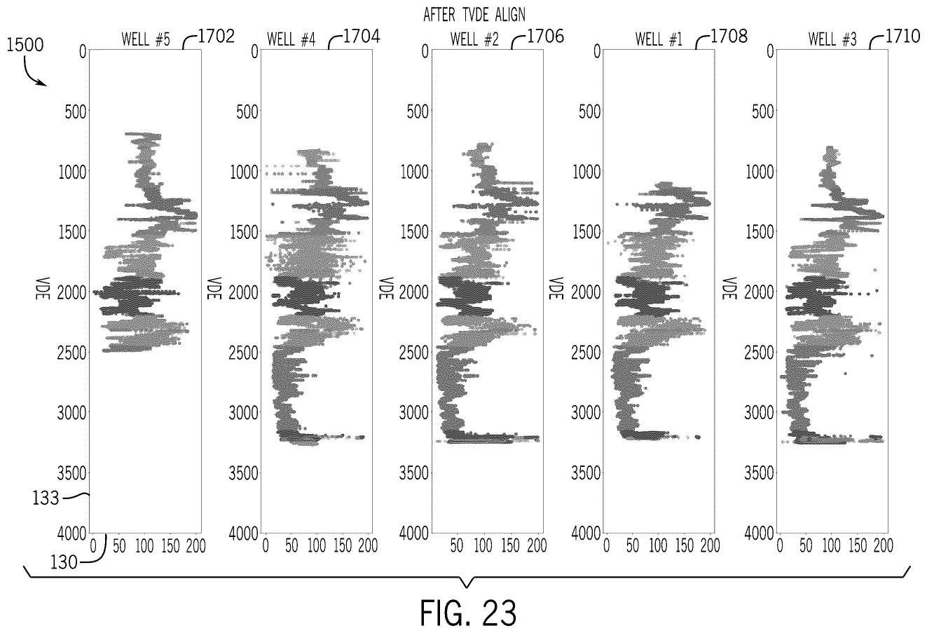

In a similar format as FIG. 22, FIG. 23 depicts the second set of example gamma-ray logs 1500 output from the method 800 of FIG. 18 after the True Vertical Depths Estimated (TVDE) alignment. Each example gamma-ray log corresponds to an offset well and the gamma-ray values are plotted as the gamma-ray (GR) value 130 (in API units) versus the True Vertical Depths Estimated (TVDE) 133 (in feet). For example, plots 1502, 1504, 1506, 1508, and 1510 depict the output gamma-ray logs after the TVDE alignment from the method 800 corresponding to different offset wells, including Well #5, Well #4, Well #2, Well #1, and Well #3). The results depicted in FIG. 23 signify the labels for the extracted formations for different offset wells after the TVDE alignment. Different colored log sections correspond to different formation types and an opacity of each point represents the probabilistic natures of a corresponding label.

The automated extraction of formation information described in the method 800 provides an automated form of extracting formation information from existing logging data (e.g., offset well logs). The automated extraction may be used to facilitate formation extractions, which traditionally involve manual processes (e.g., picking formation tops by Subject Matter Experts (SMEs)) that may consume a significant amount of time. Moreover, manually marked formation tops may be different based on the granularity that SMEs look for and may be different based on different SMEs' viewpoints. Using the automated extraction of formation information may provide fast turnaround formation information extractions with improved accuracy, in comparison to the manual processes.

For instance, the technique described in the method 800 may provide an automated system for identifying different formations and formation tops. In certain cases where a manual process is used, the identified formations and/or formation tops may be used as a guidance for the manual process by providing an initial start that may speed up the manual process. In certain embodiments, the automated system may provide a functionality for changing the granularity of an observation window while maintaining the same set of predictions through different runs.

The automated extraction of formation information described in the method 800 may also provide users with certain guidelines related to the formations that may help improving designs of real-time automated systems, such as Digital Log Generation, Real-time Rate-of-Penetration (ROP) predictions, ROP optimization, Directional Drilling workflow, and so forth. For example, the automated extraction of formation information may be used as a module of the Digital Log Generation that may automatically generate the labels (e.g., probabilistic labels), which may enable further machine learning workflows.

In certain embodiments, the automated extraction of formation information described in the method 800 may use input data including combined different types of logs, such as combined sonic and resistivity logs with gamma-ray logs to perform the similar methodology described herein. Such input data with richer information of the subsurface formations may enable predictions of various wellbore logs with improved accuracy and efficiency.

### Section 4 Physics Model Design Using Trajectory Information

As previously described, a digital gamma-ray log generation (e.g., based on the physics-informed machine learning (PIML) framework) may be used to generate the digital gamma-ray logs in real time with reduced input data dependency. The digital gamma-ray log generation may combine physics models with machine learning (ML) models to build a hybrid data-driven model (e.g., data-driven ML model (G_{ML}) 314), which is more robust than other methods without using a physics model. The digital gamma-ray log generation based on the data-driven model may produce gamma-ray logs that is physically valid. Moreover, using hybrid data-driven model may increase the capability of identifying certain important geophysical information, such as a trajectory of the well based on azimuth, inclination, depth, or any other relevant information. This may enable a user to include different geological effects, such as faults and different positions of the formation tops, into the data-driven model, thereby generating (e.g., by model predictions) more accurate gamma-ray logs.

Certain information, such as gamma-ray information, measured depth, survey information of a set of offset wells, and plan information of a subject well to be (or under) developed, may be used to build a physics (or physics-based) model for generating gamma-ray logs for the subject well. The subject well may correspond to the same geographical region as the offset wells and have similar gamma-ray distribution as the offset wells. The gamma-ray log distribution of the offset wells is also similar to each other.

Measuring gamma-ray logs across all offset wells in a particular geographical location may be costly. For example, gamma-ray logging tools have to be deployed to in each and every offset well, which is expensive and cumbersome. Additionally, gamma-ray recording accuracy (e.g., associated with continuous measurement) may not be reliable. Alternatively, a physics model may be used as an estimation to the original gamma-ray readings of the subject well, thereby minimizing cost and human effort in the measurement of gamma-ray. The selected offset wells and the subject well belong to a same or similar geographic region and share a similar formation structure (e.g., based on a direct comparison of geological features of the geographic regions and formation structures). As such, the physics-based gamma-ray log estimation may serve as a viable replacement for the original gamma-ray logs. The physics model may use physics knowledge to enhance a learning process for the hybrid data-driven model. The physics model may also be used in various applications that include usage of gamma-ray readings, such as digital log generation, ROP prediction, directional drilling workflow, and so forth.

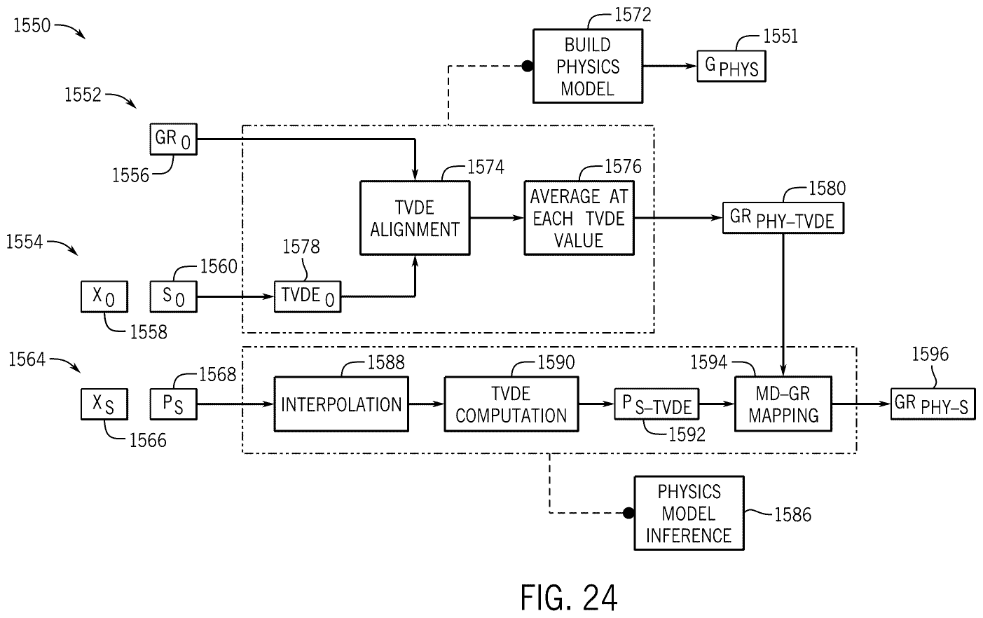

FIG. 24 depicts an example flow diagram of a method 1550 for generating a physics model (e.g., a baseline physics model G_{PHY-S}) 1551. The method 1550 includes interpolating certain geological/geophysical data, such as inclination, azimuth, and Measured Depth (MD) values, calculating the True Value Depth Estimated (TVDE), and computing the baseline physics model using physics formulas described below.

Certain definitions and formulas used in the method 1550 for generating the baseline physics model are provided below:

$$D 1 = Measured Depth value at index i from plan data , \\ D 2 = Measured Depth value at index i + 1 from plan data , \\ I 1 = {INCL}_{i - 1} ( Inclination value at depth D 1 from plan data ) , \\ I 2 = {INCL}_{i} ( Inclination value at depth D 2 from plan data ) , \\ A 1 = {AZIM}_{i - 1} ( Azimuth value at depth D 1 from plan data ) , \\ A 2 = {AZIM}_{i} ( Azimuth value at depth D 2 from plan data ) , \\ diff\_D = D 2 - D 1 , \\ Dog\_Leg = {Cos}^{- 1} ( Cos ( I 2 - I 1 ) - Sin ( I 1 ) \times Sin ( I 2 ) \times ( 1 - Cos ( A 2 - A 1 ) ) ) \div 2 , \\ RF = diff\_D 1 \times Tan ( Dog\_Leg ) \div Dog\_Leg \div 2 , \\ RF = 1 , if Dog\_Leg is 0 , \\ diff\_TVD = RF \times ( Cos ( I 1 ) + Cos ( I 2 ) ) , \\ diff\_TVDE = Difference in the TVDE values at index i and index i + 1.$$

As illustrated in FIG. 24, the method 1550 may use input data 1552 for generating the baseline physics model (G_{PHY-S}) 1551 based on the definitions and formulas described above. For example, the method 1550 may use a set of offset wells with measured depth (MD), true values of depth estimated (e.g., TVDE), and gamma-ray information, to compute the baseline physics model (G_{PHY-S}) 1551. In particular, the input data 1552 may include offset well data (Wₒ) 1554, such as gamma-ray logs (GRₒ) 1556, drilling parameters (Xₒ) 1558, and survey data (Sₒ) 1560. The input data may also include subject well data (Wₛ) 1564, such as drilling parameters (Xₛ) 1566 and plan data (Pₛ) 1568.

The method 1550 may use various modules for generating pre-processed gamma-ray logs (e.g., averaged gamma-ray value based on True Value Depth Estimated (TVDE) using the baseline physics model (G_{PHY-S}) 1551 based on the input data 1552. For example, the method 1550 may use a physics model building module 1572 for building the baseline physics model (G_{PHY-S}) 1551. The physics model building module 1572 may include a True Value Depth Estimated (TVDE) alignment module 1574 for aligning the TVDE and an averaging module 1576 for computing an average at each TVDE value. For example, the TVDE alignment module 1574 may align the gamma-ray logs (GRₒ) 1556 across different offset wells based on the True Vertical Depth (TVD). In some embodiments, certain prior knowledge (e.g., knowledge of a basin where the gamma-ray system (e.g., logging and control system 56) may use the same setting to cluster different gamma-ray segments on multiple wells and obtain an alignment for each well individually. Logs (GRₒ) 1556 corresponding to different wells are drilled) may be used to align the gamma-ray logs (GRₒ) 1556 across different offset wells.

The TVDE alignment module 1574 may align the gamma-ray logs (GRₒ) 1556 using additional information associated with the offset wells. For example, certain offset well data (Wₒ) 1554, such as drilling parameters (Xₒ) 1558 and survey data (Sₒ) 1560 may be used to calculate the True Value Depth Estimated of the offset wells (TVDEₒ) 1578. The TVDE alignment module 1574 may align the gamma-ray logs (GRₒ) 1556 across different offset wells based on the TVDEₒ 1578. The averaging module 1576 may use the aligned gamma-ray logs (GRₒ) 1556 to compute an averaged gamma-ray value (GR_{PHY-TVDE}) 1580 at each TVDE value.

The method 1550 may use a physics model inference module 1586 for inferencing the averaged gamma-ray value (GR_{PHY-TVDE}) 1580 generated from the physics model building module 1572. The method 1550 may include an interpolation module 1588, a TVDE computation module 1590, and a MD-GR (MEASURED DEPTH-Gamma-ray) mapping module 1594. For example, the interpolation module 1588 may interpolate the plan data (Pₛ) 1568 using certain geological/geophysical information, such as inclination, azimuth, and Measured Depth (MD) values. The TVDE computation module 1590 may calculate TVDE values (e.g., TVDE-based plan data (PS-TVDE) 1592) based on interpolated plan data (Pₛ) 1568 of the offset wells at each point of depth with a TVDE value.

The MD-GR mapping module 1594 may round the TVDE value for each offset well to the nearest integer and compute an average value across gamma-ray values at the same value of rounded-off depth for a respective offset well. Furthermore, the MD-GR mapping module 1594 may compute a gamma-ray average across different offset wells for a particular value of depth, resulting in a mapping of the TVDE and gamma-ray. The TVDE-GR mapping may serve as the baseline physics-guided gamma-ray estimation of the subject well. At this point, information regarding TVDE for the subject well may not be available until a drilling process associated with the subject well starts. The drilling process may provide certain drilling-related data, such as the drilling parameters (Xₛ) 1566 and plan data (Pₛ) 1568. Based on the drilling-related data of the subject well, the physics model inference module 1586 may convert the TVDE-GR mapping into an MD-GR mapping in a scale of Measured Depth (MD), such as gamma-ray indexed on MD-scale.

For example, the MD-GR mapping module 1594 may arrange the plan data (Pₛ) 1568 of the subject well in a particular order (e.g., increasing order of MD). Based on the formulas mentioned above, the MD-GR mapping module 1594 may compute a TVDE difference between every two consecutive data points in the plan data. The absolute value of the TVDE may be taken to be zero for the first data point. The TVDE difference is calculated at each point and added to the previous index's TVDE to obtain the current index's TVDE.

Next, the MD-GR mapping module 1594 may use the mapping of the TVDE and gamma-ray generated for the offset wells to map the calculated TVDE value (e.g., TVDE-based plan data (PS-TVDE) 1592). Based on the mapped TVDE values, the MD-GR mapping module 1594 may assign a gamma-ray value (e.g., inferenced values from the averaged gamma-ray value (GR_{PHY-TVDE}) 1580) at each value of MD in the plan data (Pₛ) 1568 of the subject well, creating final physics-based gamma-ray estimations (e.g., gamma-ray logs (GR_{PHY-S}) 1596) for the subject well.

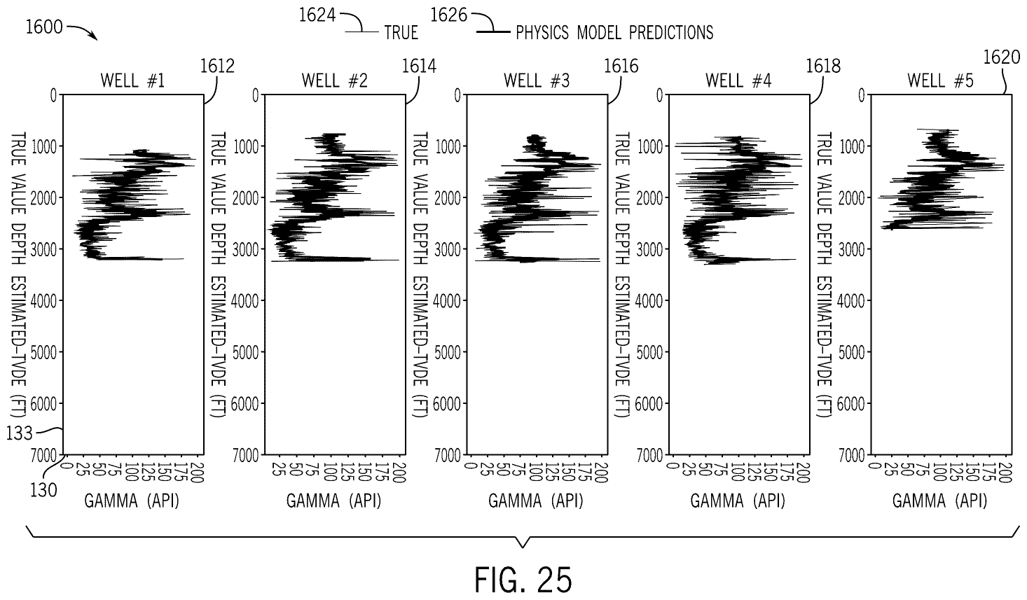

With the foregoing in mind, FIGS. 25-28 show certain results of the predicted gamma-ray logs using the baseline physics model (e.g., G_{PHY-S}) 1551) based on a set of offset wells (e.g., Well #1, Well #2, Well #3, Well #4, and Well #5) indexed on the True Vertical Depths Estimated (TVDE). A subject well may be selected (e.g., randomly) from any of the offset well (e.g., Well #1). For each well taken as the subject well, the wells (e.g., Well #2, Well #3, Well #4, and Well #5) other than the subject well (Well #1) are considered as the offset wells.

After selecting the subject well and the offset wells, using the method 1550 described above with respect to FIG. 24, a baseline physics model (e.g., baseline physics model (e.g., G_{PHY-S}) 1551) may be generated (e.g., using the physics model building module 1572). The baseline physics model may be used to generate gamma-ray value (e.g., GR_{PHY-TVDE} 1580) indexed on TVDE-scale based on offset well data (e.g., gamma-ray logs (GRO) 1556) and plan data of the subject well (e.g., plan data Pₛ 1568 associated with Well #1). Next, an inference module (e.g., physics model inference module 1586) may generate final physics-based gamma-ray estimations indexed on MD-scale for the subject well (e.g., gamma-ray logs (GR_{PHY-S}) 1596).

For example, FIG. 25 depicts a set of plots 1600 including true gamma-ray values and corresponding predicted gamma-ray (GR) values generated from the physics model (e.g., G_{PHY-S}) 1551) of FIG. 24, for the set of offset wells in a first depth range (in 1000-3200 feet, approximately). Each plot depicts the true gamma-ray 1624 in the gamma-ray (GR) value 130 (in API units) versus the corresponding predicted gamma-ray (GR) 1626 in the True Vertical Depths Estimated (TVDE) 133 (in feet). The set of plots 1600 validate a matching between the true gamma-ray 1624 and the predicted gamma-ray (GR) 1626 in the first depth range.

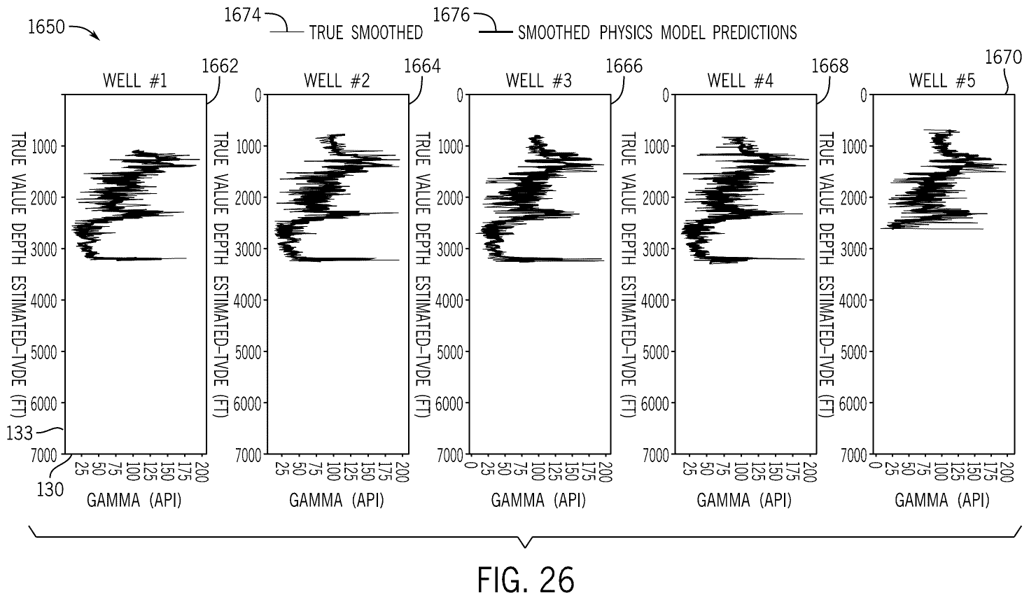

In a similar format as the FIG. 25, FIG. 26 depicts a set of plots 1650 including smoothed true gamma-ray values and corresponding smoothed predicted gamma-ray (GR) values generated from the physics model of FIG. 24, for the set of offset wells in the first depth range (in 1000-3200 feet, approximately). Each plot depicts the smoothed true gamma-ray 1674 in the gamma-ray (GR) value 130 (in API units) versus the corresponding smoothed predicted gamma-ray (GR) 1676 in the True Vertical Depths Estimated (TVDE) 133 (in feet). The set of plots 1650 validate a matching between the smoothed true gamma-ray 1674 and the smoothed predicted gamma-ray (GR) 1676 in the first depth range.

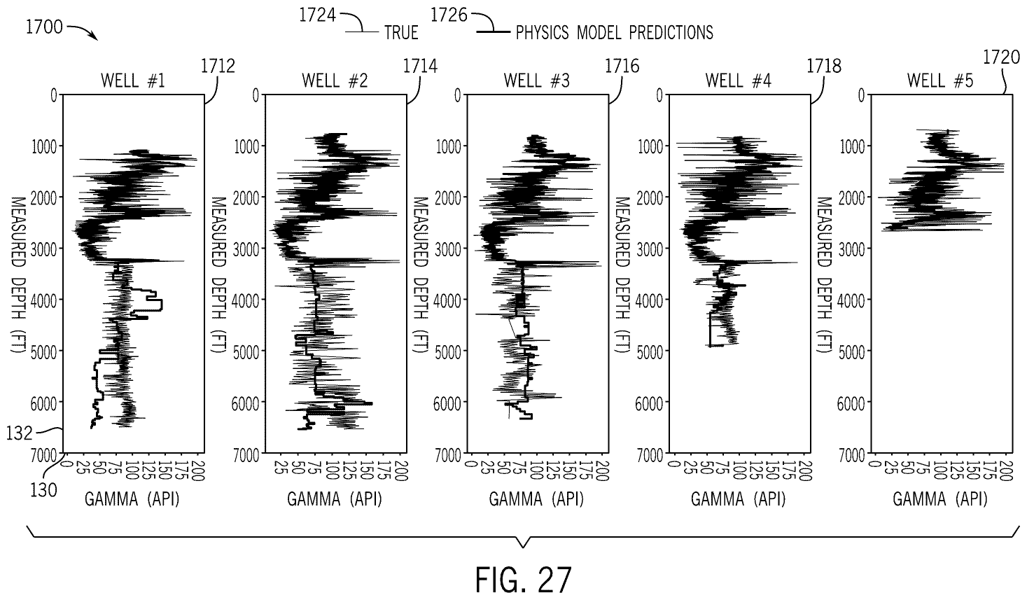

For another example, FIG. 27 depicts a set of plots 1700 including true gamma-ray values and corresponding predicted gamma-ray (GR) values generated from the physics model (e.g., G_{PHY-S}) 1551) of FIG. 24, for the set of offset wells in a second depth range (in 1000-6500 feet, approximately). Each plot depicts the true gamma-ray 1724 in the gamma-ray (GR) value 130 (in API units) versus the corresponding predicted gamma-ray (GR) 1726 in the True Vertical Depths Estimated (TVDE) 133 (in feet). The set of plots 1600 validate a matching between the true gamma-ray 1724 and the predicted gamma-ray (GR) 1726 in the second depth range.

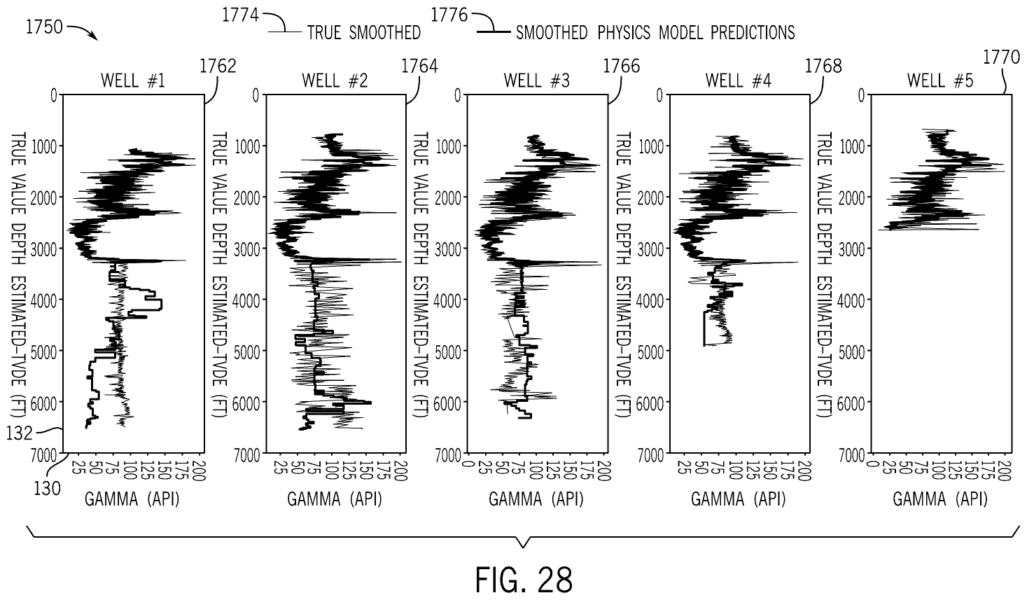

In the similar format as the FIG. 27, FIG. 28 depicts a set of plots 1750 including smoothed true gamma-ray values and corresponding smoothed predicted gamma-ray (GR) values generated from the physics model of FIG. 24, for the set of offset wells in the first depth range (in 1000-6500 feet, approximately). Each plot depicts the smoothed true gamma-ray 1774 in the gamma-ray (GR) value 130 (in API units) versus the corresponding smoothed predicted gamma-ray (GR) 1776 in the True Vertical Depths Estimated (TVDE) 133 (in feet). The set of plots 1750 validate a matching between the smoothed true gamma-ray 1774 and the smoothed predicted gamma-ray (GR) 1776 in the second depth range.

Based on the matchings, such as the matching between the true and the predicted gamma-ray values (without smoothing) in the set of plots 1600 in the first depth range (1000-3200 feet, approximately), the matching between the true and the predicted gamma-ray values (with smoothing) in the set of plots 1650 in the first depth range, the matching between the true and the predicted gamma-ray values (without smoothing) in the set of plots 1700 in the second depth range (1000-6500 feet, approximately), and the matching between the true and the predicted gamma-ray values (with smoothing) in the set of plots 1750 in the second depth range, it is evident that the baseline physics model (e.g., baseline physics model (e.g., G_{PHY-S}) 1551) built using the method 1550 described above with respect to FIG. 24 is capable of generating predicted gamma-ray logs for a subject well that match the true (e.g., measured) gamma-ray logs.

### Section 5 Digital GR Log Generation Using PIML Framework (Example II)

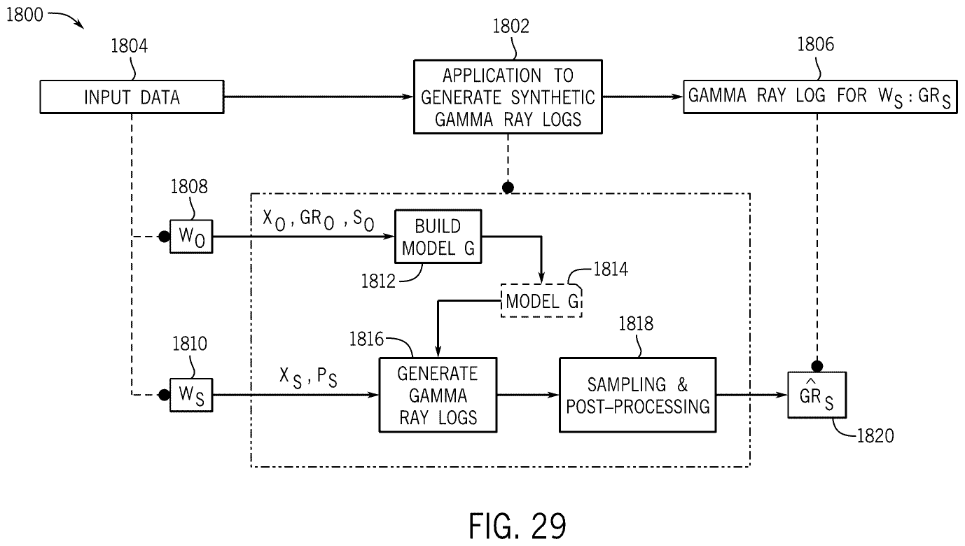

FIG. 29 depicts a second example formulation 1800 for gamma-ray log generation using data from the wellsite system 10 of FIG. 1 and the well control system 58 of FIG. 2. Although the second example formulation 1800 may use similar notations (e.g., notations of input/out data, modules, models), it should be noted the contents or functionalities associated with each element (e.g., data, module, model) may be different from the first example formulation 200.

The formulation 1800 includes an application 1802 that uses input data 1804 to generate gamma-ray logs (GRₛ) 1806 (e.g., predicted synthetic gamma-ray logs). For example, the input data 1804 may include offset well data (Wₒ) 1808 associated with a set of offset wells such as offset wells 20A and 20B. The Wₒ may include the drilling parameters (Xₒ) such as data associated with the deploying system 32, the gamma-ray logs (GRₒ) such as measured logs from downhole equipment 42, and the survey data (Sₒ) such as data measurement from the surface equipment 50 and other systems or components related to the offset wells 20A and 20B.

The input data 1804 may also include subject well data (Wₛ) 1810 associated with a subject well (e.g., subject well 20C) for which the gamma-ray logs are to be generated. The Wₛ may include the drilling parameters (Xₛ) such as data associated with drilling operations in the subject well 20C, and the plan data (Pₛ) such as planning the subject well 20C (e.g., initial drilling, plugging, and abandonment).

The application 1802 may include a variety of modules, such as a model building module 1812, a gamma-ray log generation module 1816, and a sampling and post-processing module 1818. The model building module 1812 may use physics models (e.g. the baseline physics model (e.g., G_{PHYS}) 1551) and machine learning algorithms to build a model (G) 1814. The gamma-ray log generation module 1816 may use the model (G) 1814 to generate the gamma-ray logs (GRₛ) 1820 for the subject well 20C. In certain embodiments, the sampling and post-processing module 1818 may sample the gamma-ray logs (GRₛ) 1820 (e.g., to match measured gamma-ray logs of the offset wells 20A and 20B in sample rate). In certain embodiments, the sampling and post-processing module 1818 may perform other post-processing, such as de-noise, smoothing, and so forth.

Using the additional input data and additional functionalities associated with the additional input data, the 1814 built using the formulation 1800 under the PIML framework may predict gamma-ray logs for the subject well with improved data quality (e.g., prediction accuracy) and reduced turnaround time that may enable real-time applications during a well development process. The improved gamma-ray data quality and real-time capability provide enhanced solutions that may lower the cost of Measuring While Drilling (MWD), Logging While Drilling (LWD), or other processes, and facilitate the geoscientists to make data driven decisions.

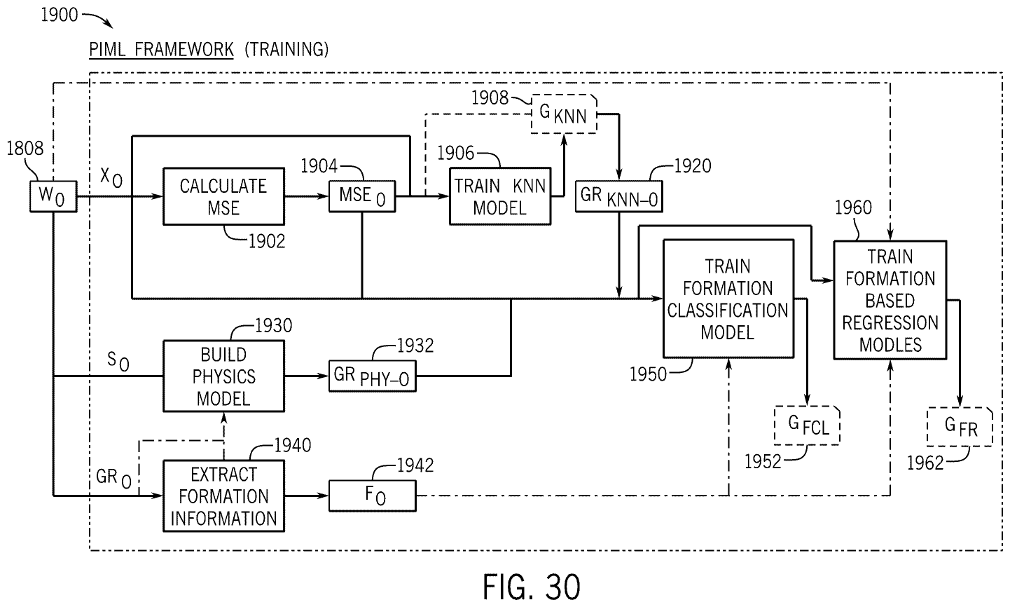

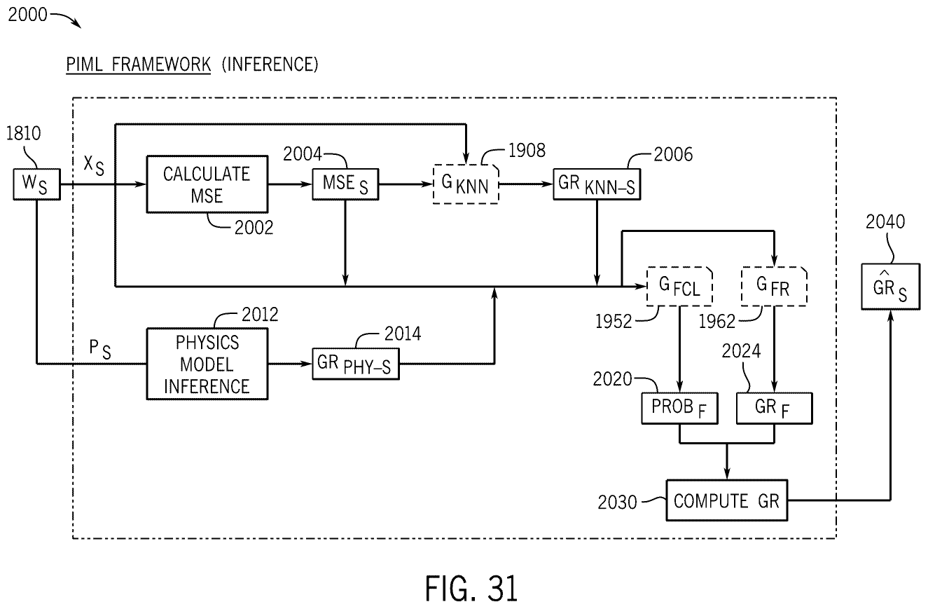

With the preceding in mind, and to provide further familiarity with principle of automated digital gamma-ray generation using the Physics-informed Machine Learning (PIML) framework, FIGS. 30-31 illustrate flow diagrams of the PIML framework for different processes in generating predicted gamma-ray logs for a subject well using various input data, including data from the subject well and data from one or more offset wells analogous to the subject well in terms of the gamma-ray distributions.

For example, FIG. 30 depicts a flow diagram of the physics-informed machine learning (PIML) framework based on the formulation 1800 of FIG. 29 for a training process 1900. The training process 1900 may include various model training modules for generating training and different algorithm-based models, and training the models based on the training data and other relevant data from the offset well data (e.g., Wₒ 1808). A computing system may perform actions described below in the training process 1900. The computing system may include the logging and control system 56, cloud computing system using the cloud computing resources 74, external computing systems 76 that may access and/or to remotely interact with the logging and control system 56, or a combination thereof.

The computing system may receive the input data (e.g., offset well data (Wₒ) 1808) associated with a set of offset wells (e.g., offset wells 20A and 20B) and stored locally (e.g., using the one or more storage media 64 of the logging and control system 56) or remotely (e.g., using one or more cloud storages associated with the cloud computing resources 74 or external computing systems 76). The offset well data (Wₒ) 1808 may include drilling parameters (Xₒ) such as data associated with the deploying system 32, gamma-ray logs (GRₒ) such as measured logs from downhole equipment 42, and survey data (Sₒ) such as data measurement from the surface equipment 50 and other systems or components related to the offset wells 20A and 20B.

A Mechanical Specific Energy (MSE) calculation module 1902 may compute MSEₒ 1904 for an offset well based on the drilling parameters (Xₒ). The MSEₒ 1904 may include the energy for removing a unit volume of a rock formation. The MSE calculation module 1902 may use different forces, such as Weight on Bit (WOB) responsible for indenting the rock formation and Torque (TQX) responsible for breaking the identified rock formation. These forces may act independently. For example, axial work done may be determined by WOB and an axial distance per time may be determined by Rate of Penetration (ROP). The rotational work done may be calculated using TQX and Revolutions per Minute (RPM). The total work done may be divided by the volume of the rock to calculate the MSEₒ 1904. Calculating the MSEₒ 1904 may be controlled using drilling parameters, including TQX, RPM, ROP, and SWOB (planned lifting of well fluids to the surface).

A formula used to calculate the MSEₒ 1904 may be given as:

$$MSE = ( ( 120 * TQX * RPM ) / ( ROP ) + ( SWOB / pi ) ) * ( 4 / D 2 ) ,$$

where TQX is the torque, RPM is the Revolutions Per Minute, ROP is the Rate Of Penetration, SWOB is Surface Weight On Bit, and D is the diameter of the drill bit.

In certain embodiments, the MSE calculation module 1902 may not learn (e.g., using machine learning algorithms) anything from the input data. For example, the MSE calculation module 1902 may use certain given data to derive the MSE value. As such, the MSE calculation may not depend on a learning based on the input data. Therefore, the MSE calculation module 1902 may adapt to the input data and does not need any retraining.

A first training module 1906 may use the MSEₒ 1904 as input to train a K-Nearest Neighbors (KNN) model (G_{KNN}) 1908. The KNN model (G_{KNN}) 1908 (after training) may be used to generate KNN-model based gamma-ray logs (GR_{KNN-O}) 1920 for the offset well based on the MSEₒ 1904, the drilling parameters (Xₒ), and the gamma-ray logs (GRₒ).

A physics model building module 1930 may create a physics model based on the survey data (Sₒ), the gamma-ray logs (GRₒ), and formation information. In certain embodiments, the physics model building module 1930 may use K-Nearest Neighbors (KNN) algorithm, the gamma-ray logs (GRₒ), the formation information, and the survey data (Sₒ) to create the physics model (e.g., similar to the physics model (G_{PHY}) 312 created using the KNN algorithm). In certain embodiments, the physics model building module 1930 may use a set of offset wells with measured depth (MD), true values of depth estimated (e.g., TVDE), and the gamma-ray logs (GRₒ) to create the physics model (e.g., similar to the baseline physics model (G_{PHY-S}) 1551). The physics model may generate physics-model based gamma-ray logs (GR_{PHY-O}) 1932.

A formation information extraction module 1940 may extract formation information (Fₒ) 1942 associated with subsurface formations surrounding the offset wells based on the gamma-ray logs (GRₒ). The formation information extraction may use the automated extraction of formation information described in the method 800. For example, the formation information extraction module 1940 may use the gamma-ray logs (GRₒ) collected (e.g., by the logging and control system 56) from offset wells (e.g., offset wells 20A and 20B) to extract latent information. The extraction may include breaking down or segmenting the gamma-ray logs (GRₒ) based on certain criteria (e.g., different energies) using spectral analysis techniques, applying clustering techniques to identify the cluster centers each having a unique shape, identifying a center (e.g., mean representation) for each cluster, calculating the similarities between rolling segments on the original gamma-ray log and the center, assigning a set of labels for each particular points in depth, assigning the set of labels for each of the particular points based on a maximum voting among the overlapping segments, determining whether an alignment on the True Vertical Depth (TVD) is needed, and aligning the gamma-ray logs across different offset wells based on the TVD, generating formation information based on the aligned gamma-ray logs and probabilistic labels assigned to the particular points in depth.

A second training module 1950 may use a variety of datasets to train a formation classification model (G_{FCL}) 1952. The variety of datasets may include the drilling parameters (Xₒ), the KNN-model based gamma-ray logs (GR_{KNN-O}) 1920, the formation information (Fₒ) 1942, and the MSEₒ 1904. In certain embodiments, an eXtreme Gradient Boosting (XGBoost) classification model may be used to predict formation classes. For each formation class, the eXtreme Gradient Boosting (XGBoost) classification model may predict a probability based on the observed drilling parameters (Xₒ).

A formation class having the highest probability may be defined as C*, and the number of formation classes may be defined as N based on the number of formations observed from the formation information (Fₒ) 1942. Training data, such as drilling parameters (Xₒ), the KNN-model based gamma-ray logs (GR_{KNN-O}) 1920, the formation information (Fₒ) 1942, and the MSEₒ 1904, may be used to train the formation classification model (G_{FCL}) 1952 (e.g., an eXtreme Gradient Boosting (XGBoost) classification model). The trained formation classification model (G_{FCL}) 1952 may output N predicted gamma-ray values, GR_{F0}, GR_{F1} . . . GR_{FN-1}. The N predicted gamma-ray values may include the gamma-ray value (GR_{Fc*}) corresponding to class C*.

A third training module 1960 may use certain data, such as the drilling parameters (Xₒ), the MSEₒ 1904, the KNN-model based gamma-ray logs (GR_{KNN-O}) 1920, and the formation information (Fₒ) 1942, to train a formation-based regression model (G_{FR}) 1962. The formation-based regression model (G_{FR}) 1962 may generate the final predicted gamma-ray logs for the subject well.

The formation-based regression model (G_{FR}) 1962 may selectively (e.g., based on user instructions) output weighted gamma-ray predictions or unweighted predictions. The unweighted gamma-ray predictions may include GR_{Fc*} corresponding to the maximum probability class (e.g., class C*). The weighted gamma-ray predictions may include a summation of multiplications between the probability of each class (Prob_{Fi}) obtained from an eXtreme Gradient Boosting classification model and the predicted gamma-ray (GR_{Fi}) obtained from N Accelerated Bayesian Additive Regression Trees (XBART) models, where “i” is from 0 to N-1 representing different formations.

FIG. 31 depicts a flow diagram of the physics-informed machine learning (PIML) framework based on the formulation 1800 of FIG. 29 for an inference process 2000. The inference process 2000 may include various modules for computing intermediate data for generating the final predicted gamma-ray logs for the subject well based on physics and machine learning models generated and trained in the training process 1900. A computing system may perform actions described below in the inference process 2000. The computing system may include the logging and control system 56, cloud computing system using the cloud computing resources 74, external computing systems 76 that may access and/or to remotely interact with the logging and control system 56, or a combination thereof.

The inference process 2000 may receive the input data (e.g., subject well data (Wₛ) 1810) associated with the subject wells (e.g., subject well 20C) and stored locally (e.g., using the one or more storage media 64 of the logging and control system 56) or remotely (e.g., using one or more cloud storages associated with the cloud computing resources 74 or external computing systems 76). The subject well data (Wₛ) 1810 may include drilling parameters (Xₛ) and plan data (Pₛ) associated with the subject well.

A Mechanical Specific Energy (MSE) calculation module 2002 may compute MSEₛ 2004 for the subject well based on the drilling parameters (Xₛ). The MSEₛ 2004 may include the energy for removing a unit volume of a rock formation. The MSE calculation module 2002 may use different forces, such as Weight on Bit (WOB) responsible for indenting the rock formation and Torque (TQX) responsible for breaking the identified rock formation. These forces may act independently. For example, axial work done may be determined by WOB and an axial distance per time may be determined by Rate of Penetration (ROP). The rotational work done may be calculated using TQX and Revolutions per Minute (RPM). The total work done may be divided by the volume of the rock to calculate the MSEₛ 2004. Calculating the MSEₛ 2004 may be controlled using drilling parameters, including TQX, RPM, ROP, and SWOB (planned lifting of well fluids to the surface).

The KNN model (G_{KNN}) 1908 built in the process 1900 may use the MSEₛ 2004 and the drilling parameters (Xₛ) to generate KNN-model based gamma-ray logs (GR_{KNN-s}) 2006 for the subject well. The GR_{KNN-S} 2006 may be used as an input for the formation classification model (G_{FCL}) 1952 built in the process 1900 to generate, for example, N predicted gamma-ray values, GR_{F0}, GR_{F1} . . . GR_{FN-1}.

A physics model inference module 2012 may use the plan data (Pₛ) associated with the subject well to inference a physics model associated with the subject well. For example, the physics model inference module 2012 may include a physics model building module 1930 that may use algorithms (e.g., K-Nearest Neighbors (KNN) algorithm) and the formation information to create the physics model. In certain embodiments, the physics model building module 1930 may use a set of offset wells with measured depth (MD), true values of depth estimated (e.g., TVDE), and the gamma-ray logs (GRₒ) to create the physics model (e.g., similar to the baseline physics model (G_{PHY-S}) 1551). The physics model with the subject well may generate synthetic gamma-ray logs (GR_{PHY-s}) 2014.

The formation classification model (G_{FCL}) 1952 built in the process 1900 may use the drilling parameters (Xₛ), the MSEₛ 2004, the GR_{KNN-S} 2006, and the GR_{PHY-S}) 2014 to generate probabilities (Prob_{F}) 2020. The Prob_{F} 2020 may include the probability of each class (Prob_{Fi}) obtained from an eXtreme Gradient Boosting classification model, where “i” is from 0 to N-1 representing different formations.

The formation-based regression model (G_{FR}) 1962 built in the process 1900 may use the drilling parameters (Xₛ), the MSEₛ 2004, the GR_{KNN-S} 2006, and the GR_{PHY-s}) 2014 to generate predicted gamma-ray logs (GR_{F}) 2024. The GR_{F} 2024 may include the predicted gamma-ray values obtained from N Accelerated Bayesian Additive Regression Trees (XBART) models, where “i” is from 0 to N-1 representing different formations.

A gamma-ray computing module 2030 may use the probabilities (Prob_{F}) 2020 and the predicted gamma-ray logs (GR_{F}) 2024 to generate the final predicted gamma-ray logs (GRₛ) 2040 for the subject well.

### Section 6 Offset Well Selection

The physics-informed machine learning (PIML) framework based on the formulation 800 or the formulation 1800 predicts gamma-ray logs for a subject well based on combined physics and machine learning models using measured gamma-ray logs collected from one of more offset wells. In certain cases, relationships between the surface measurements and gamma-ray may be relatively complex and may vary with respect to different subsurface formations and different regions. The complex and varying relationships may create challenges for predicting synthetic gamma-ray logs for the subject well using the data from the offset wells.

For example, a digital gamma-ray log generation application based on the PIML framework may use offset well data for learning particular relationships based on the machine learning models. In certain cases, the offset well data may be the only data on which a model is built for learning (e.g., using machine learning) relationships between surface features and the gamma-rays. In such cases, a performance of the model may depend considerably on the offset well data. For example, the performance of the model may include the quality of the learning results, such as a matching between learned relationships and the actual relationships between the surface measurements and gamma-ray). It is important to select the offset wells suitable for the digital gamma-ray log generation application. For example, the selected offset wells need to be analogous to the subject well in terms of gamma-ray readings (e. g., a distribution of the subsurface formations within the specific area are similar).

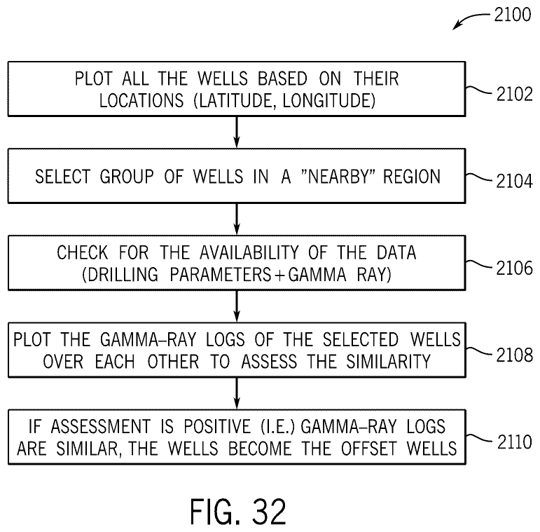

The performance of the model used in the digital gamma-ray log generation application depends on the data quality from the selected offset wells. FIG. 32 depicts an example flow diagram of a method 2100 for selecting offset wells for the physics-informed machine learning (PIML) framework. In certain embodiments, a computing system, such as the logging and control system 56, the computing system 76, other computing system(s) in the cloud computing 74, and so forth, may perform operations described herein via one or more processors (e.g., the processor 62 based on processor-executable code stored in the storage media 64). Although the method 2100 described in FIG. 32 is described in a particular order, it should be noted that the method 2100 may be performed in any suitable order and is not limited to the order presented herein.

Referring now to FIG. 32, at process block 2102, the computing system plots all the wells based on location data. For example, the computing system may receive location data associated with a subject well (e.g., subject well 20C) and a set of wells (e.g., wells 20A and 20B). For example, the location data may include geographic coordinates from a spherical or ellipsoidal coordinate system measuring positions (e.g., well positions) directly on the Earth, such as latitude and longitude values of the subject well and the set of wells. In certain embodiments, the location data may be recorded in the offset well data (Wₒ) 1808 (e.g., drilling parameters (Xₒ), gamma-ray logs (GRₒ), and survey data (Sₒ)) and subject well data (Wₛ) 1810 (e.g., drilling parameters (Xₛ) and plan data (Pₛ)).

At process block 2104, the computing system selects a group of wells from the set of offset wells. In certain embodiments, the selection may be based on the location data. For example, the group of wells may be selected based on determining the locations of the group of wells are near to the subject well (e.g., within a threshold distance from the subject well). In certain embodiments, additional selection may be performed to the group of wells. For example, the additional selection may be performed based on determining where a well in the group of wells is analogous to the subject well in terms of gamma-ray readings (e. g., a distribution of the subsurface formations within the specific area are similar).

At process block 2106, the computing system checks for the availability of data associated with the group of wells. For example, the computing system may query a database for well data associated with the group of wells, such as the drilling parameters (Xₒ), the gamma-ray logs (GRₒ), subsurface formation information, survey data (Sₒ), and other data related to the group of wells.

At process block 2108, the computing system plots the gamma-ray logs of the selected wells. For example, the gamma-ray logs (GRₒ) associated with each selected well may be plotted over each other, forming an overlaid plot that may enable assessing the similarity between the selected wells.

Based on the similarity assessment, at process block 2110, the computing system determines whether the group of wells are qualified as offset wells. For example, the computing system may determine that an assessment of a candidate group of wells is positive based on the similarities of the gamma-ray readings among the candidate group of wells. The higher similarity of the gamma-ray logs of two wells, the more analogous (e.g., more similar subsurface formations between the two wells).

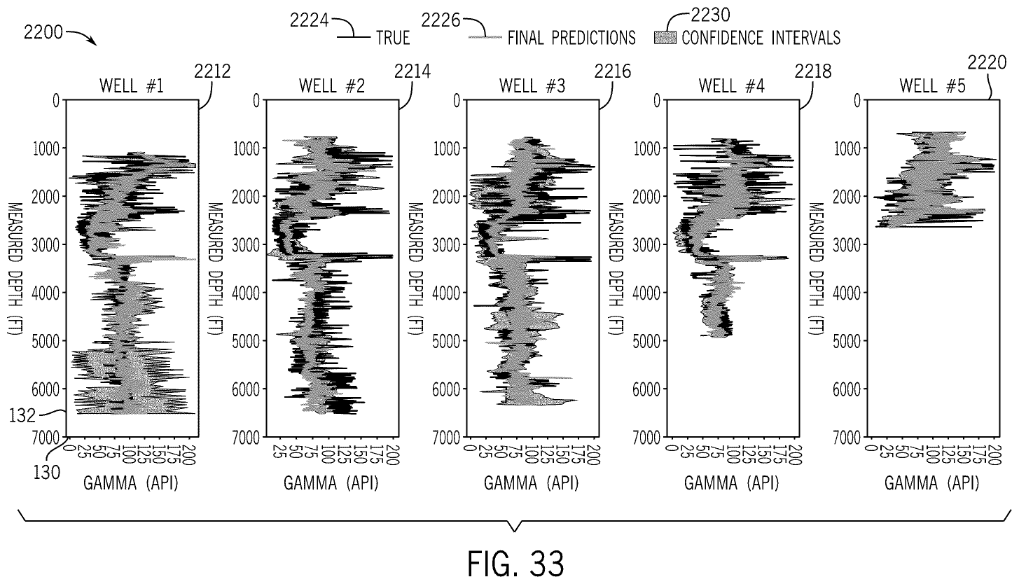

Each of FIGS. 33-36 depicts a set of plots including true gamma-ray values, corresponding predicted gamma-ray (GR) values generated from the formulation 1800 of FIG. 29 based on selected wells using the method 2100 of FIG. 32 from historically collected data of different wells, and corresponding confidence intervals extracted based on the standard deviations of the gamma-ray predictions from each of the different formation-based regression models. Using the available location data (e.g., locations of the wells), a computing system based on the method 2100 clusters the well data and recursively divides the well data into sub-groups. After an analysis for the similarity of the nature of the gamma-ray logs, a final subgroup of five wells is obtained, including Well #1, Well #2, Well #3, Well #4, and Well #5. The selected five different wells are determined to be analogous to each other in the way the gamma-ray has been distributed for them. Next, the computing system performs a Leave-One-Out validation for each of the five wells and selects four wells as the offset wells and the remaining one well as the subject well. The same process is repeated for all the five wells and each of them may be selected to be the subject well once.

For example, FIG. 33 depicts a set of plots 2200 including true gamma-ray values and corresponding predicted gamma-ray (GR) values with the confidence intervals using the second formulation 1800 of FIG. 29 based on selected wells using the method 2100 of FIG. 32. Each plot depicts the true gamma-ray 2224 in the gamma-ray (GR) value 130 (in API units) versus the corresponding predicted gamma-ray (GR) 2226 in the Measured Depth (MD) (in feet) with the confidence interval 2230 extracted based on the standard deviation of the corresponding predicted gamma-ray (GR) 2226. The set of plots 2200 validate a matching between the true gamma-ray 2224 and the predicted gamma-ray (GR) 2226 in each of the five wells.

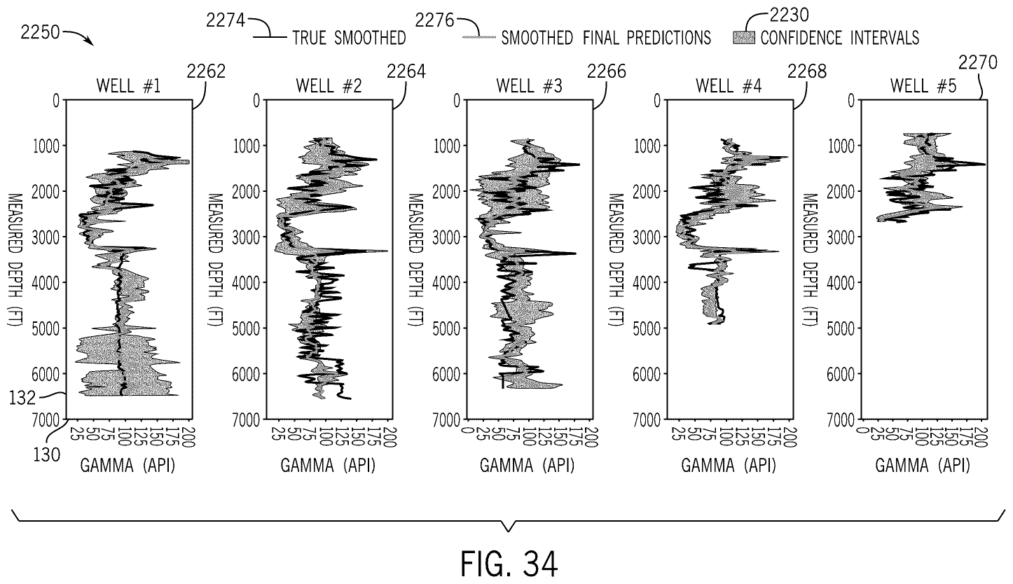

In a similar format as the FIG. 33, FIG. 34 depicts a set of plots 2250 including smoothed true gamma-ray values and corresponding smoothed predicted gamma-ray (GR) values with confidence intervals using the second formulation 1800 of FIG. 29 based on selected wells using the method 2100 of FIG. 32. Each plot depicts the smoothed true gamma-ray 2274 in the gamma-ray (GR) value 130 (in API units) versus the corresponding predicted gamma-ray (GR) 2276 in the Measured Depth (MD) (in feet) with the confidence interval 2280 extracted based on the standard deviation of the corresponding predicted gamma-ray (GR) 2274. The set of plots 2250 validate a matching between the true gamma-ray 2274 and the predicted gamma-ray (GR) 2276 in each of the five wells.

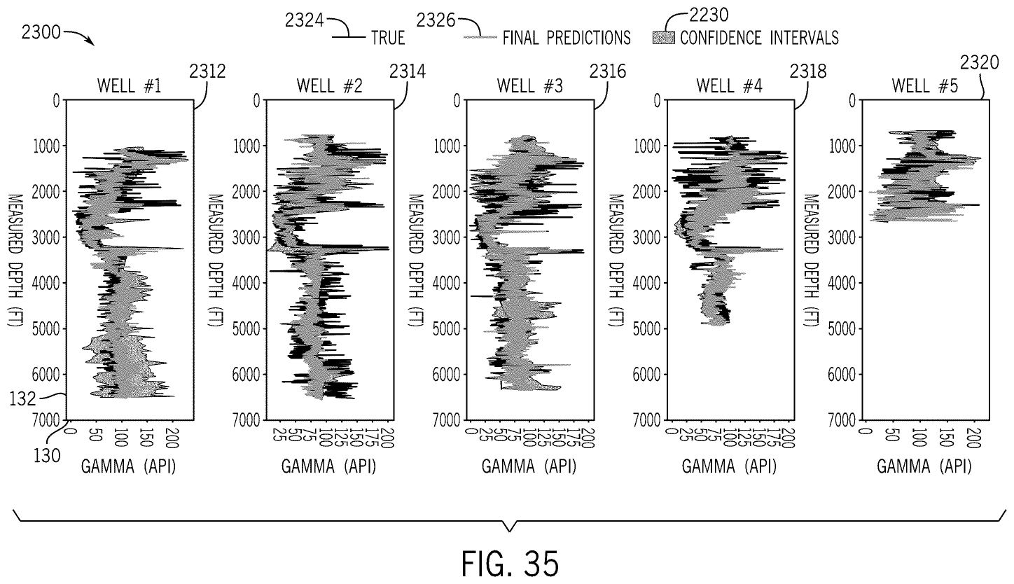

FIG. 35 depicts a set of plots 2300 including true gamma-ray values and corresponding predicted and weighted gamma-ray (GR) values with confidence intervals using the second formulation 1800 of FIG. 29 based on selected wells using the method 2100 of FIG. 32. Each plot depicts the true gamma-ray 2324 in the gamma-ray (GR) value 130 (in API units) versus the corresponding predicted gamma-ray (GR) 2326 in the Measured Depth (MD) (in feet) with the confidence interval 2330 extracted based on the standard deviation of the corresponding predicted gamma-ray (GR) 2326. The set of plots 2300 validate a matching between the true gamma-ray 2324 and the predicted gamma-ray (GR) 2326 in each of the five wells.

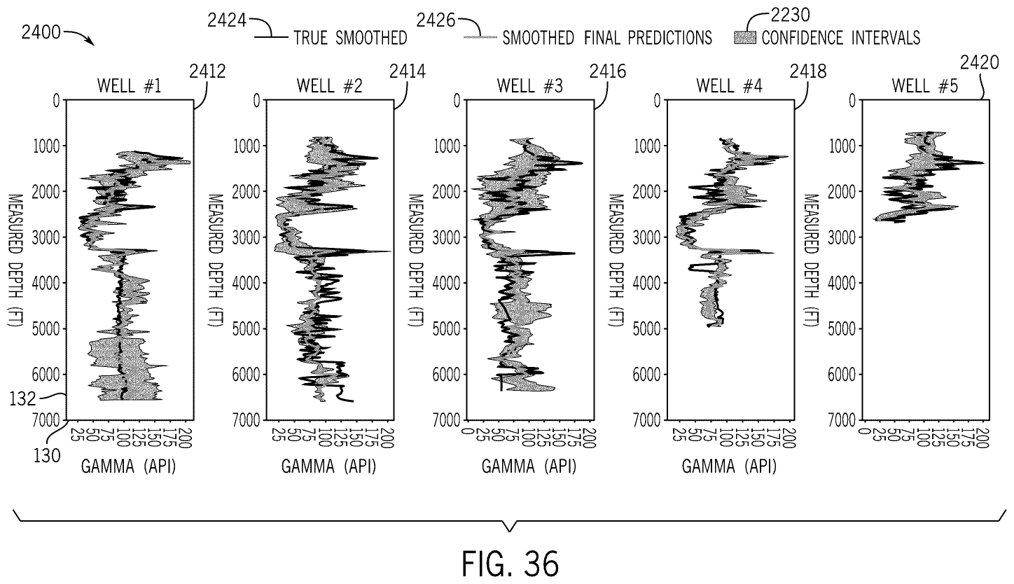

In a similar format as the FIG. 35, FIG. 36 depicts a set of plots 2400 including smoothed true gamma-ray values and corresponding smoothed predicted and weighted gamma-ray (GR) values with confidence intervals using the second formulation 1800 of FIG. 29 based on selected wells using the method 2100 of FIG. 32. Each plot depicts the smoothed true gamma-ray 2424 in the gamma-ray (GR) value 130 (in API units) versus the corresponding predicted gamma-ray (GR) 2426 in the Measured Depth (MD) (in feet) with the confidence interval 2430 extracted based on the standard deviation of the corresponding predicted gamma-ray (GR) 2424. The set of plots 2400 validate a matching between the true gamma-ray 2424 and the predicted gamma-ray (GR) 2426 in each of the five wells.

The plots in FIGS. 33-36 show that the predicted gamma-ray data for each subject well using the physics-informed machine learning (PIML) framework matches the trends in the offset well data. Moreover, the plots in FIGS. 33-36 show the predicted gamma-ray data is able to be used to capture certain particular spikes. Further, the plots in FIGS. 33-36 show that the unweighted gamma-ray predictions are more centralized. The predicted gamma-ray logs may be used to approximate each crest and trough, allowing users (e.g., drillers and geoscientists) to perform certain preliminary analysis (e.g., analysis on locations of the drill bits, formation types) that may provide guidelines for particular drilling process (e.g., directional drilling).

The systems and methods described in present disclosure provide systems and methods for generating digital gamma-ray logs for target wells based on combined physics and machine learning model using real-time information (e.g., drilling parameters, survey data, gamma-ray logs) obtained from offset wells analogous to the subject well in terms of gamma-ray readings. The techniques described herein may provide solutions that may lower the cost of Measuring While Drilling (MWD) and/or Logging While Drilling (LWD) process and facilitate the users (e.g., drillers, geoscientists) to make enhanced data driven decisions.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method for generating log data, comprising:
receiving input data associated with a target well in an area comprising a plurality of subsurface formations and one or more offset wells that are analogous to the target well;
building a physics-informed machine learning model using one or more algorithms based at least in part on the input data associated with the target well and one or offset wells;
training the physics-informed machine learning model using at least the input data associated with the one or more offset wells; and
generating log data associated with the target well using the physics-informed machine learning model based at least in part on the input data associated with the target well.

2. The method of claim 1, wherein the log data comprises gamma-ray logs.

3. The method of claim 2, wherein the one or more offset wells are analogous to the target well with respect to gamma-ray readings indicative of a same or similar distribution of the plurality of subsurface formations associated with the one or more offset wells and the target well.

4. The method of claim 3, wherein the physics-informed machine learning model is trained to learn a relationship between drilling measurements and the gamma-ray readings.

5. The method of claim 1, wherein building the physics-informed machine learning model comprises:
selecting the one or more offset wells based at least in part on location data and a similarity analysis;
creating a physics model based at least in part on the input data associated with the one or more offset wells;
extracting formation information associated with the plurality of subsurface formations;
creating the physics-informed machine learning model based at least in part on the physics model, the extracted formation information, and the input data associated with the subject well, wherein the physics-informed machine learning model comprises a plurality of models; and
training the physics-informed machine learning model using the input data associated with the one or more offset wells.

6. The method of claim 5, wherein building the physics-informed machine learning model comprises:
generating a probability for each class of a plurality of classes associated with the plurality of subsurface formations using the physics-informed machine learning model and the input data associated with the subject well;
generating predicted gamma-ray values associated with the plurality of subsurface formations using the physics-informed machine learning model and the input data associated with the subject well; and
generating the log data associated with the target well using the probability for each class of the plurality of classes and the predicted gamma-ray values.

7. The method of claim 6, wherein the plurality of models comprises the physics model, a formation information extraction model, a K-Nearest Neighbors (KNN) model, a formation classification model, a plurality of formation-based regression models, or some combination thereof.

8. A logging and control system, comprising:
one or more processors configured to execute processor-executable instructions stored on memory media of the logging and control system, wherein the processor-executable instructions, when executed by the one or more processors, cause the logging and control system to:
receive input data associated with a target well in an area comprising a plurality of subsurface formations and one or more offset wells that are analogous to the target well;
build a physics-informed machine learning model using one or more algorithms based at least in part on the input data associated with the target well and one or offset wells;
train the physics-informed machine learning model using at least the input data associated with the one or more offset wells; and
generate log data associated with the target well using the physics-informed machine learning model based at least in part on the input data associated with the target well.

9. The logging and control system of claim 8, wherein the log data comprises gamma-ray logs.

10. The logging and control system of claim 9, wherein the one or more offset wells are analogous to the target well with respect to gamma-ray readings indicative of a same or similar distribution of the plurality of subsurface formations associated with the one or more offset wells and the target well.

11. The logging and control system of claim 10, wherein the processor-executable instructions, when executed by the one or more processors, cause the logging and control system to train the physics-informed machine learning model to learn a relationship between drilling measurements and the gamma-ray readings.

12. The logging and control system of claim 8, wherein building the physics-informed machine learning model comprises:
selecting the one or more offset wells based at least in part on location data and a similarity analysis;
creating a physics model based at least in part on the input data associated with the one or more offset wells;
extracting formation information associated with the plurality of subsurface formations;
creating the physics-informed machine learning model based at least in part on the physics model, the extracted formation information, and the input data associated with the subject well, wherein the physics-informed machine learning model comprises a plurality of models; and
training the physics-informed machine learning model using the input data associated with the one or more offset wells.

13. The logging and control system of claim 12, wherein building the physics-informed machine learning model comprises:
generating a probability for each class of a plurality of classes associated with the plurality of subsurface formations using the physics-informed machine learning model and the input data associated with the subject well;
generating predicted gamma-ray values associated with the plurality of subsurface formations using the physics-informed machine learning model and the input data associated with the subject well; and
generating the log data associated with the target well using the probability for each class of the plurality of classes and the predicted gamma-ray values.

14. The logging and control system of claim 13, wherein the plurality of models comprises the physics model, a formation information extraction model, a K-Nearest Neighbors (KNN) model, a formation classification model, a plurality of formation-based regression models, or some combination thereof.

15. A tangible non-transitory computer-readable medium comprising processor-executable instructions, wherein the processor-executable instructions, when executed by one or more processors, cause the one or more processors to:
receive input data associated with a target well in an area comprising a plurality of subsurface formations and one or more offset wells that are analogous to the target well;
build a physics-informed machine learning model using one or more algorithms based at least in part on the input data associated with the target well and one or offset wells;
train the physics-informed machine learning model using at least the input data associated with the one or more offset wells; and
generate log data associated with the target well using the physics-informed machine learning model based at least in part on the input data associated with the target well.

16. The tangible non-transitory computer-readable medium of claim 15, wherein the log data comprises gamma-ray logs.

17. The tangible non-transitory computer-readable medium of claim 16, wherein the one or more offset wells are analogous to the target well with respect to gamma-ray readings indicative of a same or similar distribution of the plurality of subsurface formations associated with the one or more offset wells and the target well.

18. The tangible non-transitory computer-readable medium of claim 17, wherein the processor-executable instructions, when executed by the one or more processors, cause the one or more processors to train the physics-informed machine learning model to learn a relationship between drilling measurements and the gamma-ray readings.

19. The tangible non-transitory computer-readable medium of claim 15, wherein building the physics-informed machine learning model comprises:
selecting the one or more offset wells based at least in part on location data and a similarity analysis;
creating a physics model based at least in part on the input data associated with the one or more offset wells;
extracting formation information associated with the plurality of subsurface formations;
creating the physics-informed machine learning model based at least in part on the physics model, the extracted formation information, and the input data associated with the subject well, wherein the physics-informed machine learning model comprises a plurality of models;
training the physics-informed machine learning model using the input data associated with the one or more offset wells;
generating a probability for each class of a plurality of classes associated with the plurality of subsurface formations using the physics-informed machine learning model and the input data associated with the subject well;
generating predicted gamma-ray values associated with the plurality of subsurface formations using the physics-informed machine learning model and the input data associated with the subject well; and
generating the log data associated with the target well using the probability for each class of the plurality of classes and the predicted gamma-ray values.

20. The tangible non-transitory computer-readable medium of claim 19, wherein the plurality of models comprises the physics model, a formation information extraction model, a K-Nearest Neighbors (KNN) model, a formation classification model, a plurality of formation-based regression models, or some combination thereof.
